(19) United States
(12) Patent Application Publication
(10) Pub. No.: US 2026/0261470 A1
(43) Pub. Date: Sep. 3, 2026

(54) BIT-LEVEL PROBABILISTIC SHAPING FOR WIRELESS COMMUNICATIONS

(71) Applicant: QUALCOMM Incorporated, San Diego, CA (US)

(72) Inventors: Wei YANG, San Diego, CA (US); Jing JIANG, San Diego, CA (US); Liangming WU, Beijing (CN)

(21) Appl. No.: 19/159,975

(22) PCT Filed: Apr. 19, 2023
(86) PCT No.: PCT/CN2023/089132

§ 371 Date: Aug. 26, 2025

(51) Int. Cl. H04L 27/34; H04L 1/00; H04L 5/00

(52) U.S. Cl. CPC H04L 27/3411; H04L 1/0042; H04L 5/0055

(57) ABSTRACT

Methods, systems, and devices for wireless communications are described. A first wireless device (e.g., transmitting (Tx) device) may apply a probabilistic shaping operation to a data payload to form two or more bit streams of non-uniformly distributed bits. The first wireless device may apply a bit transformation to the two or more bit streams in order to generate a corresponding two or more transformed bit streams. The first wireless device may then modulate bits from the two or more transformed bit streams to a set of symbols of a modulation constellation in accordance with a Gray mapping to generate a message including the data payload, where a probability distribution of the set of symbols after the modulation is monotonic. The first wireless device may then transmit the message to a second wireless device (e.g., receiving (Rx) device).

### CROSS REFERENCE

The present Application is a 371 national phase filing of International PCT Application No. PCT/CN2023/089132 by YANG et al., entitled “BIT-LEVEL PROBABILISTIC SHAPING FOR WIRELESS COMMUNICATIONS,” filed Apr. 19, 2023, which is assigned to the assignee hereof, and which is expressly incorporated by reference in its entirety herein.

### FIELD OF TECHNOLOGY

The following relates to wireless communications, including bit-level probabilistic shaping for wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications systems may utilize “probabilistic shaping” modulation schemes which map bits of data to points in a modulation constellation such that the constellation points are used with uneven equal probability. In some cases, bits may be mapped to the constellation points according to a Gray mapping to enable reduced bit errors for communicated messages. However, conventional probabilistic shaping techniques, when combined with Gray mapping, may result in a non-monotonic probability distribution, where the distribution of probability of each constellation point in the mapping results in some constellation points further from the origin being used with a higher probability as compared to some constellation points closer to the origin. Points further from the origin may require more transmit energy as compared to points closer to the origin, meaning the non-monotonic probability distribution may be less energy efficient as compared to a monotonic probability distribution.

### SUMMARY

The described techniques relate to improved methods, systems, devices, and apparatuses that support bit-level probabilistic shaping for wireless communications. Generally, aspects of the present disclosure are directed to bit-level probabilistic shaping and modulation techniques. In particular, aspects of the present disclosure are directed to modulation techniques that use bit-level shaping to shape bit streams according to non-Gray mappings, and bit transformations that transform the non-Gray mapping to Gray mapping for communicating a message from a transmitting (Tx) device to a receiving (Rx) device. For example, a Tx device may apply a shaping operation to generate multiple bit streams of non-uniformly shaped bits. The Tx device may subsequently apply a bit transformation to generate transformed bit streams, and generate a message by mapping/modulating the transformed bit streams to a modulation constellation in accordance with a Gray mapping. By applying the transformation, the probability distribution of the symbols after mapping may be made monotonic (whereas the probability distribution of the symbols after the mapping without the transformation would be non-monotonic). Subsequently, the Tx device may transmit the modulated message to an Rx device.

A method is described. The method may include applying a probabilistic shaping operation to a data payload to form two or more bit streams of non-uniformly distributed bits, applying a bit transformation to the two or more bit streams in order to generate a corresponding two or more transformed bit streams, modulating bits from the two or more transformed bit streams to a set of symbols of a modulation constellation in accordance with a Gray mapping to generate a message including the data payload, where a probability distribution of the set of symbols after the modulating is monotonic, and transmitting the message to a second wireless device.

An apparatus is described. The apparatus may include a processor, memory coupled with the processor, and instructions stored in the memory. The instructions may be executable by the processor to cause the apparatus to apply a probabilistic shaping operation to a data payload to form two or more bit streams of non-uniformly distributed bits, apply a bit transformation to the two or more bit streams in order to generate a corresponding two or more transformed bit streams, modulate bits from the two or more transformed bit streams to a set of symbols of a modulation constellation in accordance with a Gray mapping to generate a message including the data payload, where a probability distribution of the set of symbols after the modulating is monotonic, and transmit the message to a second wireless device.

Another apparatus is described. The apparatus may include means for applying a probabilistic shaping operation to a data payload to form two or more bit streams of non-uniformly distributed bits, means for applying a bit transformation to the two or more bit streams in order to generate a corresponding two or more transformed bit streams, means for modulating bits from the two or more transformed bit streams to a set of symbols of a modulation constellation in accordance with a Gray mapping to generate a message including the data payload, where a probability distribution of the set of symbols after the modulating is monotonic, and means for transmitting the message to a second wireless device.

A non-transitory computer-readable medium storing code is described. The code may include instructions executable by a processor to apply a probabilistic shaping operation to a data payload to form two or more bit streams of non-uniformly distributed bits, apply a bit transformation to the two or more bit streams in order to generate a corresponding two or more transformed bit streams, modulate bits from the two or more transformed bit streams to a set of symbols of a modulation constellation in accordance with a Gray mapping to generate a message including the data payload, where a probability distribution of the set of symbols after the modulating is monotonic, and transmit the message to a second wireless device.

In some examples of the method, apparatuses, and non-transitory computer-readable medium described herein, communicating, with the second wireless device, control signaling that indicates one or more parameters associated with the probabilistic shaping operation, the bit transformation, or both, where application of at least one of the probabilistic shaping operation or the bit transformation may be performed in accordance with the one or more parameters.

In some examples of the method, apparatuses, and non-transitory computer-readable medium described herein, the one or more parameters include a quantity of bits of the data payload that may be shaped according to the probabilistic shaping operation, an indication that the probabilistic shaping operation includes a conditional shaping operation, an unconditional shaping operation, or both, a relative ordering between the bit transformation and the probabilistic shaping operation, a shaping distribution of the probabilistic shaping operation, a shaping rate of the probabilistic shaping operation, an indication of the bit transformation applied to the two or more bit streams, or any combination thereof.

In some examples of the method, apparatuses, and non-transitory computer-readable medium described herein, a mapping of the bits from the two or more bit streams across the set of symbols of the modulation constellation in accordance with the Gray mapping would result in a non-monotonic probability distribution of the set of symbols.

Some examples of the method, apparatuses, and non-transitory computer-readable medium described herein may further include operations, features, means, or instructions for applying the probabilistic shaping operation results in respective first probability distributions corresponding to each of the two or more bit streams being conditionally independent relative to one another and applying the bit transformation results in respective second probability distributions corresponding to each of the two or more transformed bit streams being not conditionally independent relative to one another.

Some examples of the method, apparatuses, and non-transitory computer-readable medium described herein may further include operations, features, means, or instructions for applying a forward error correction (FEC) procedure to the two or more transformed bit streams and to an additional bit stream of uniformly distributed bits, where the additional bit stream may be derived from the data payload without application of the probabilistic shaping operation or the bit transformation, and where modulating the bits of the two or more transformed bit streams may be performed based on applying the FEC procedure.

In some examples of the method, apparatuses, and non-transitory computer-readable medium described herein, the probabilistic shaping operation includes a conditional shaping operation and probabilistic shaping of the two or more bit streams may be conditional on the additional bit stream.

In some examples of the method, apparatuses, and non-transitory computer-readable medium described herein, applying the probabilistic shaping operation may include operations, features, means, or instructions for applying the probabilistic shaping operation in parallel to form the two or more bit streams of non-uniformly distributed bits based on the probabilistic shaping operation including the unconditional shaping operation.

In some examples of the method, apparatuses, and non-transitory computer-readable medium described herein, applying the probabilistic shaping operation may include operations, features, means, or instructions for applying the first shaping operation to form the first bit stream of non-uniformly distributed bits and applying the second shaping operation to form the second bit stream of non-uniformly distributed bits based on shaping the first bit stream, and based on the probabilistic shaping operation including the conditional shaping operation.

Some examples of the method, apparatuses, and non-transitory computer-readable medium described herein may further include operations, features, means, or instructions for applying the first shaping operation in accordance with a target distribution to form the first bit stream of non-uniformly distributed bits, where application of the second shaping operation may be conditional on the first bit stream.

Some examples of the method, apparatuses, and non-transitory computer-readable medium described herein may further include operations, features, means, or instructions for applying an additional probabilistic shaping operation to form a third bit stream of non-uniformly distributed bits, where application of the additional probabilistic shaping operation may be conditional on the two or more bit streams or the two or more transformed bit streams and applying the bit transformation to the third bit stream to generate a third transformed bit stream corresponding to the third bit stream, where modulating the bits of the two or more transformed bit streams may be based on mapping the third transformed bit stream to the modulation constellation.

In some examples of the method, apparatuses, and non-transitory computer-readable medium described herein, the bit transformation includes a linear transformation that may be configured to convert bit streams associated with a non-Gray mapping to bit streams associated with a Gray mapping.

In some examples of the method, apparatuses, and non-transitory computer-readable medium described herein, the two or more bit streams include a first bit stream and a second bit stream associated with non-Gray mappings and the linear transformation may be configured to transform the first bit stream to a first transformed bit stream associated with a Gray mapping, and transform a combination of the first bit stream and the second bit stream to a second transformed bit stream associated with a second Gray mapping.

In some examples of the method, apparatuses, and non-transitory computer-readable medium described herein, the probability distribution of the set of symbols after the modulating may be monotonic such that symbols of the modulation constellation with lower magnitudes or transmit powers may be associated with a higher distribution probability as compared to symbols with higher magnitudes or transmit powers.

A method is described. The method may include receiving a message from a first wireless device, demodulating the message by mapping a set of symbols of a modulation constellation to bits of two or more transformed bit streams in accordance with a Gray mapping, where a probability distribution of the set of symbols prior to the demodulating is monotonic, applying a bit transformation to the two or more transformed bit streams in order to generate a corresponding two or more bit streams of non-uniformly distributed bits, applying a reverse probabilistic distribution operation to the two or more bit streams of non-uniformly distributed bits to retrieve a data payload of the message, and processing the data payload.

An apparatus is described. The apparatus may include a processor, memory coupled with the processor, and instructions stored in the memory. The instructions may be executable by the processor to cause the apparatus to receive a message from a first wireless device, demodulate the message by mapping a set of symbols of a modulation constellation to bits of two or more transformed bit streams in accordance with a Gray mapping, where a probability distribution of the set of symbols prior to the demodulating is monotonic, apply a bit transformation to the two or more transformed bit streams in order to generate a corresponding two or more bit streams of non-uniformly distributed bits, apply a reverse probabilistic distribution operation to the two or more bit streams of non-uniformly distributed bits to retrieve a data payload of the message, and process the data payload.

Another apparatus is described. The apparatus may include means for receiving a message from a first wireless device, means for demodulating the message by mapping a set of symbols of a modulation constellation to bits of two or more transformed bit streams in accordance with a Gray mapping, where a probability distribution of the set of symbols prior to the demodulating is monotonic, means for applying a bit transformation to the two or more transformed bit streams in order to generate a corresponding two or more bit streams of non-uniformly distributed bits, means for applying a reverse probabilistic distribution operation to the two or more bit streams of non-uniformly distributed bits to retrieve a data payload of the message, and means for processing the data payload.

A non-transitory computer-readable medium storing code is described. The code may include instructions executable by a processor to receive a message from a first wireless device, demodulate the message by mapping a set of symbols of a modulation constellation to bits of two or more transformed bit streams in accordance with a Gray mapping, where a probability distribution of the set of symbols prior to the demodulating is monotonic, apply a bit transformation to the two or more transformed bit streams in order to generate a corresponding two or more bit streams of non-uniformly distributed bits, apply a reverse probabilistic distribution operation to the two or more bit streams of non-uniformly distributed bits to retrieve a data payload of the message, and process the data payload.

In some examples of the method, apparatuses, and non-transitory computer-readable medium described herein, communicating, with the first wireless device, control signaling that indicates one or more parameters associated with a probabilistic shaping operation performed by the first wireless device, the bit transformation, or both, where application of at least one of the reverse probabilistic distribution operation or the bit transformation may be performed in accordance with the one or more parameters.

In some examples of the method, apparatuses, and non-transitory computer-readable medium described herein, the one or more parameters include a quantity of bits of the data payload that may be shaped according to the probabilistic shaping operation, an indication that the probabilistic shaping operation includes a conditional shaping operation, an unconditional shaping operation, or both, a relative ordering between the bit transformation and the probabilistic shaping operation, a shaping distribution of the probabilistic shaping operation, a shaping rate of the probabilistic shaping operation, an indication of the bit transformation applied to the two or more bit streams, or any combination thereof.

In some examples of the method, apparatuses, and non-transitory computer-readable medium described herein, a mapping of the bits from the two or more bit streams across the set of symbols of the modulation constellation in accordance with the Gray mapping would result in a non-monotonic probability distribution of the set of symbols.

In some examples of the method, apparatuses, and non-transitory computer-readable medium described herein, first probability distributions corresponding to each of the two or more bit streams may be conditionally independent relative to one another and second probability distributions corresponding to each of the two or more transformed bit streams may be not conditionally independent relative to one another.

In some examples of the method, apparatuses, and non-transitory computer-readable medium described herein, processing the data payload may include operations, features, means, or instructions for applying an FEC procedure to the two or more transformed bit streams and to an additional bit stream of uniformly distributed bits, where the additional bit stream of the data payload may be retrieved without application of the reverse probabilistic distribution operation or the bit transformation.

In some examples of the method, apparatuses, and non-transitory computer-readable medium described herein, the reverse probabilistic distribution operation includes a conditional distributional operation and application of the reverse probabilistic distribution operation may be conditional on the additional bit stream.

In some examples of the method, apparatuses, and non-transitory computer-readable medium described herein, applying the reverse probabilistic distribution operation may include operations, features, means, or instructions for applying the reverse probabilistic distribution operation in parallel to form the two or more bit streams of non-uniformly distributed bits based on the reverse probabilistic distribution operation including the unconditional distributional operation.

In some examples of the method, apparatuses, and non-transitory computer-readable medium described herein, the bit transformation includes a linear transformation that may be configured to convert non-Gray mapped bit streams to Gray-mapped bit streams.

In some examples of the method, apparatuses, and non-transitory computer-readable medium described herein, the probability distribution of the set of symbols prior to the demodulating may be monotonic such that symbols closer to on origin of the modulation constellation may be associated with a higher distribution probability as compared to symbols further from the origin.

### BRIEF DESCRIPTION OF THE DRAWINGS

FIG. 1 shows an example of a wireless communications system that supports bit-level probabilistic shaping for wireless communications in accordance with one or more aspects of the present disclosure.

FIG. 2 shows an example of a modulation scheme that supports bit-level probabilistic shaping for wireless communications in accordance with one or more aspects of the present disclosure.

FIG. 3 shows an example of constellation configurations that support bit-level probabilistic shaping for wireless communications in accordance with one or more aspects of the present disclosure.

FIG. 4 shows an example of a modulation scheme that supports bit-level probabilistic shaping for wireless communications in accordance with one or more aspects of the present disclosure.

FIG. 5 shows an example of a modulation scheme that supports bit-level probabilistic shaping for wireless communications in accordance with one or more aspects of the present disclosure.

FIG. 6 shows an example of a modulation scheme that supports bit-level probabilistic shaping for wireless communications in accordance with one or more aspects of the present disclosure.

FIG. 7 shows an example of a process flow that supports bit-level probabilistic shaping for wireless communications in accordance with one or more aspects of the present disclosure.

FIGS. 8 and 9 show block diagrams of devices that support bit-level probabilistic shaping for wireless communications in accordance with one or more aspects of the present disclosure.

FIG. 10 shows a block diagram of a communications manager that supports bit-level probabilistic shaping for wireless communications in accordance with one or more aspects of the present disclosure.

FIG. 11 shows a diagram of a system including a device that supports bit-level probabilistic shaping for wireless communications in accordance with one or more aspects of the present disclosure.

FIGS. 12 and 13 show block diagrams of devices that support bit-level probabilistic shaping for wireless communications in accordance with one or more aspects of the present disclosure.

FIG. 14 shows a block diagram of a communications manager that supports bit-level probabilistic shaping for wireless communications in accordance with one or more aspects of the present disclosure.

FIG. 15 shows a diagram of a system including a device that supports bit-level probabilistic shaping for wireless communications in accordance with one or more aspects of the present disclosure.

FIGS. 16 through 18 show flowcharts illustrating methods that support bit-level probabilistic shaping for wireless communications in accordance with one or more aspects of the present disclosure.

### DETAILED DESCRIPTION

Some wireless communications systems may utilize modulation schemes which map bits of data to points in a modulation constellation such that each constellation point is used with equal probability. Comparatively, other modulation schemes may utilize “probabilistic shaping” in which bits are non-uniformly distributed across constellation points of a modulation constellation (e.g., constellation points are used with uneven probability). Such probabilistic shaping may improve spectral efficiency of wireless communications, and may be used to shape the probability distribution of individual bits (e.g., bit-level shaping) or to shape the probability distribution of modulated symbols (e.g., symbol-level shaping).

After shaping, bits may be mapped to constellation points according to a Gray mapping. Gray mapping is a preferred method of mapping bit sequences to constellation points, as the mapping allows for only one bit of a sequence to change when mapping from point to point (e.g., 01, 00, 10, 11). Gray mappings enable reduced bit errors for communicated messages. However, conventional probabilistic shaping techniques, when combined with Gray mapping, may result in a non-monotonic probability distribution. In a non-monotonic probability distribution, the distribution of probability of each constellation point in the mapping results in some constellation points further from the origin being used with a higher probability as compared to some constellation points closer to the origin. Points further from the origin may require more transmit energy as compared to points closer to the origin, meaning the non-monotonic probability distribution may be less energy efficient as compared to a monotonic distribution. One solution to this is to use a non-Gray mapping after probabilistic shaping. However, while utilizing a non-Gray mapping may result in a monotonic probability distribution, such techniques may introduce higher bit error rates as compared to Gray mappings.

Accordingly, aspects of the present disclosure are directed to bit-level probabilistic shaping and modulation techniques. In particular, aspects of the present disclosure are directed to modulation techniques that use bit-level shaping to shape bit streams according to non-Gray mappings, and bit transformations that transform the non-Gray mapping to Gray mapping for communicating a message from a transmitting (Tx) device to a receiving (Rx) device.

For example, a Tx device may apply a shaping operation to generate multiple bit streams of non-uniformly shaped bits. The Tx device may subsequently apply a bit transformation to generate transformed bit streams, and generate a message by mapping/modulating the transformed bit streams to points of a modulation constellation in accordance with a Gray mapping. By applying the transformation, the distribution of the symbols after mapping and modulation may be made monotonic (whereas the distribution of the symbols after the mapping without the transformation would be non-monotonic). Subsequently, the Tx device may transmit the modulated message to an Rx device.

The Tx and Rx devices may exchange signaling that indicates parameters of the shaping operation and/or bit transformation so that the Rx device is able to un-do the transformation and shaping performed by the Tx device to retrieve the data payload of the message. Parameters of the shaping operations and/or bit transformation that may be communicated between the devices may include a quantity of bits that are subject to the shaping, whether the shaping operation includes conditional or unconditional shaping, which bit transformation was used, and the like.

Aspects of the disclosure are initially described in the context of wireless communications systems. Additional aspects of the disclosure are described in the context of example modulation schemes, an example constellation configuration, and an example process flow. Aspects of the disclosure are further illustrated by and described with reference to apparatus diagrams, system diagrams, and flowcharts that relate to bit-level probabilistic shaping for wireless communications.

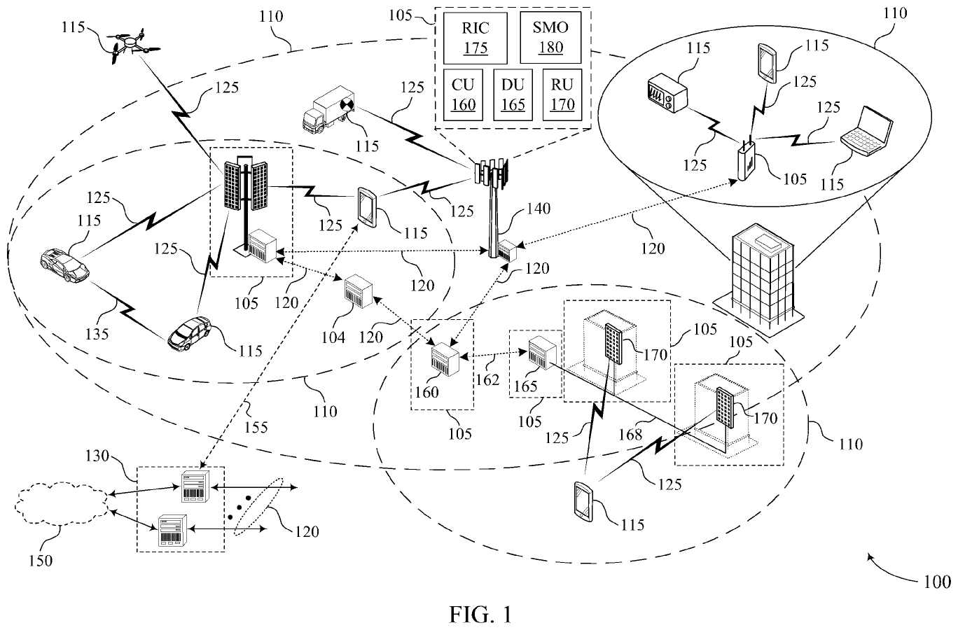

FIG. 1 shows an example of a wireless communications system 100 that supports bit-level probabilistic shaping for wireless communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125.

The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support bit-level probabilistic shaping for wireless communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δƒ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The UEs 115, network entities 105, and other wireless devices (e.g., IAB nodes) of the wireless communications system 100 may support bit-level probabilistic shaping and modulation techniques. In particular, the wireless devices of the wireless communications system 100 may be configured to support modulation techniques that use bit-level shaping to shape bit streams according to non-Gray mappings, and bit transformations that transform the non-Gray mapping to Gray mapping for communicating a message from a Tx device to an Rx device.

For example, a Tx device of the wireless communications system 100 (e.g., UE 115, network entity 105, IAB node, etc.) may apply a shaping operation to generate multiple bit streams of non-uniformly shaped bits. The Tx device may subsequently apply a bit transformation to generate transformed bit streams, and generate a message by mapping/modulating the transformed bit streams to a modulation constellation in accordance with a Gray mapping. By applying the transformation, the probability distribution of the symbols after mapping may be made monotonic (whereas the probability distribution of the symbols after the mapping without the transformation would be non-monotonic). Subsequently, the Tx device may transmit the modulated message to an Rx device (e.g., another UE 115, another network entity 105, another IAB node, etc.).

The Tx and Rx devices of the wireless communications system 100 may exchange signaling that indicates parameters of the shaping operation and/or bit transformation so that the Rx device is able to un-do the transformation and shaping performed by the Tx device to retrieve the data payload of the message. Parameters of the shaping operations and/or bit transformation that may be communicated between the devices may include a quantity of bits that are subject to the shaping, whether the shaping operation includes conditional or unconditional shaping, which bit transformation was used, and the like.

Techniques described herein may enable wireless communications to be performed using bit-level probabilistic shaping along with Gray mappings to achieve monotonic probability distributions for wireless communications. As such, techniques described herein may enable wireless devices to utilize non-Gray mappings for the purposes of probabilistic shaping, while also taking advantage of Gray mappings for the purpose of communicated messages. In this regard, aspects of the present disclosure may enable more efficient and reliable wireless communications (through the use of Gray mappings), while also reducing Tx powers used to communicate messages between devices (through the use of monotonic probability distributions).

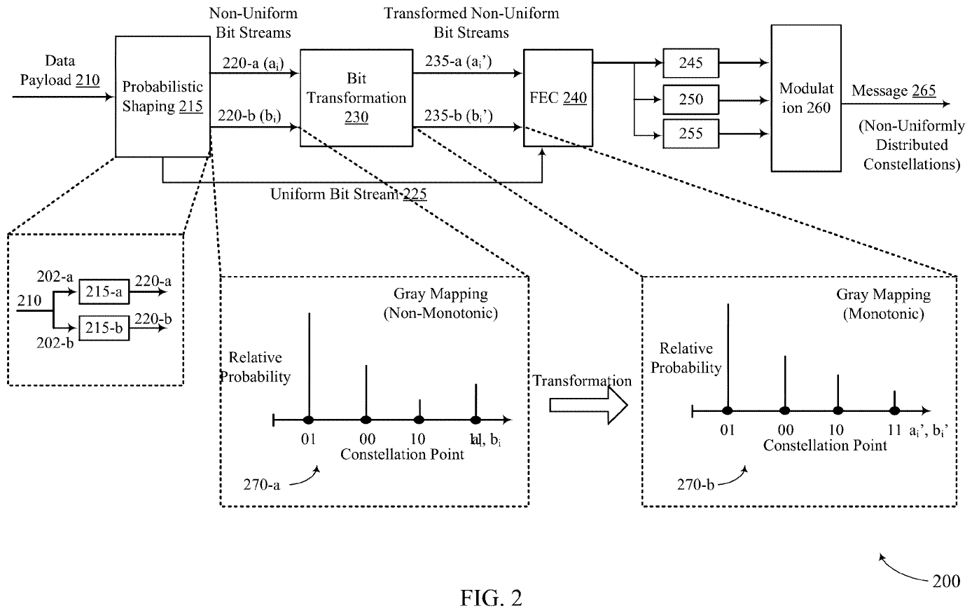

FIG. 2 shows an example of a modulation scheme 200 that supports bit-level probabilistic shaping for wireless communications in accordance with one or more aspects of the present disclosure. Aspects of the modulation scheme 200 may implement, or be implemented by, aspects of the wireless communications system 100. In particular, the modulation scheme 200 illustrated in FIG. 2 illustrates operations and communication procedures performed by a Tx device to perform bit-level probabilistic shaping for messages communicated to an Rx device.

Moreover, for the purpose of the present disclosure, aspects of the modulation scheme 200 illustrated in FIG. 2 may effectively be performed in reverse (e.g., from right to left) by an Rx device that receives messages modulated according to the bit-level probabilistic shaping techniques described herein.

In some wireless communications systems (e.g., cellular networks, Wi-Fi networks, etc.), higher-order modulation schemes, such as 16 QAM, 64 QAM, 256 QAM, 1024 QAM, etc., may be used to increase the spectral efficiency of wireless communications at higher SNR values. In such systems, modulation constellations (e.g., square constellations) may be fixed, where each constellation point of the modulation constellation is used with equal probability.

Comparatively, other wireless communications systems may utilize “probabilistic shaping” techniques that are used to generate non-uniformly distributed coded modulation symbols. That is, in the context of probabilistic shaping, bits of a message may be non-uniformly distributed across constellation points of a modulation constellation (e.g., constellation points are used with uneven probability). Probabilistic shaping techniques may be implemented to further improve the spectral efficiency of the coded modulation. In particular, it is well-known in information theory that non-uniformly distributed QAM techniques are able to achieve higher capacity than uniformly distributed QAM.

Probabilistic amplitude shaping is one form of a probabilistic shaping. In such a probabilistic shaping framework, a Tx device may identify a data payload 210 to be communicated to an Rx device, and may perform shaping (e.g., probabilistic shaping operation 215) prior to channel coding (e.g., FEC procedure 240) on information bits of the data payload 210. The Tx device may use systematic channel code to preserve the shaping applied to the information bits, where parity bits 255 are not shaped and are mapped to the signs of the modulation constellation (at modulation procedure 260).

There are different ways to perform shaping, such as based on source compression codes (e.g., Huffman codes, Arithmetic codes) or channel codes (e.g., polar codes, low-density generator matrix (LDGM) codes, convolutional codes, trellis codes, lattice codes, etc.). Moreover, for shaping purposes, there are two main approaches: (1) symbol-level shaping (shaping the probability distribution of the modulated symbol), and (2) bit-level shaping (shaping the probability distribution of the bit).

A comparison of symbol-level shaping and bit-level shaping may be analogous to binary vs. non-binary channel codes. For symbol-level shaping, the idea is to directly shape the probability of the modulated constellations. In other words, the operations involved in symbol-level shaping may be non-binary. Comparatively, for bit-level shaping, the idea is to control the probability of the information bits. In particular, after modulation, bit-level shaping may result in a corresponding probability distribution on the modulation symbol. In general, bit-level shaping may be simpler than symbol level shaping, since operations are performed on the bit level. Aspects of the present disclosure are directed to designs for bit-level shaping by exploiting intentional bit-to-constellation mappings.

In order to explain attendant advantages of the present disclosure, an example for conventional bit-level shaping may be illustrative. An example of conventional bit-level shaping may be shown with reference to portions of FIG. 2. For example, in the context of a conventional bit-level shaping procedure, a Tx device may apply a probabilistic shaping operation 215 to a data payload 210 that is to be communicated to an Rx device to generate non-uniform bits (e.g., non-uniform bit streams 220-a, 220-b). In the context of probabilistic amplitude shaping, only the amplitude of the modulation symbols of the data payload 210 may be shaped, where the sign bits are still uniform. This is because, for the optimal distribution, it suffices to take the sign bits to be uniform.

Continuing with the example of conventional bit-shaping, the non-uniform bit streams 220-a, 220-b and uniform bits (e.g., uniform bit stream 225) of the data payload 210 may be used as inputs to an FEC procedure 240. In other words, conventional bit-shaping techniques may not utilize the bit transformation 230 illustrated in FIG. 2. The FEC procedure 240 of conventional bit-shaping techniques may generate shaped systematic bits 245 and unshaped systematic bits 250, and may add parity bits 255. Subsequently, in a modulation procedure 260 (e.g., QAM modulation), the shaped systematic bits 245 may be mapped to the amplitude of the points of a modulation constellation, and the unshaped systematic bits 250 and parity bits 255 may be mapped to the sign of the points of the modulation constellation to generate a message 265. The message 265 may include non-uniformly distributed QAM constellations for the data payload 210, which may then be transmitted to an Rx device (where the Rx device may perform the described procedures/operations in reverse to obtain the data payload 210).

One or more bits of the data payload 210 may be shaped at time. In some cases of the probabilistic shaping operation 215, each three bits may map to an 8 PAM modulated symbol (e.g., the I or Q part of 64 QAM), where the two least-significant bits (LSBs) of the three bits determine the amplitude of the modulation symbol, and most-significant bit (MSB) determines the sign. For 1-bit shaping, bit-level shaping may be applied to only the first of the LSBs to achieve a desired distribution. For instance, for 1-bit shaping, the LSBs may be shaped by letting Pr(a₁=0)=0.7, Pr(a₁=1)=0.3, and letting Pr(b₁=0)=Pr(b₁=0)=0.5. Using a Gray mapping, as shown in the constellation points of the first constellation configuration 270-a in FIG. 2 (for 4ASK, illustrating the amplitude portion of 8 PAM), such a 1-bit mapping may result in a probability distribution of 0.35 for constellation points “01” and “00,” and a probability distribution of 0.15 for constellation points “10” and “11.”

In other cases, more than one bit may be shaped per real constellation (e.g., 2-bit shaping, 3-bit shaping, etc.). There are multiple ways to implement multi-bit shaping. For example, in accordance with a first implementation of 2-bit shaping illustrated in FIG. 2, the Tx device may utilize two separate bit-level probability shapers (e.g., separate probabilistic shaping operations 215-a and 215-b) to shape a first bit stream 202-a (a₁) and a second bit stream 202-b (b₁), respectively. In such cases, the respective probability shapers (e.g., respective probabilistic shaping operations 215-a, 215-b) may include or utilize either compression code-based shaping (e.g., constant-composition distribution matcher (CCDM), arithmetic code, Huffman code, sphere codes, etc.) or channel code-based shaping (e.g., polar code-based shaping, LDGM based shaping, convolutional code based shaping, trellis code based shaping, etc.). In this regard, the first probabilistic shaping operation 215-a may shape the first bit stream 202-a to generate a first non-uniform bit stream 220-a as an output. Similarly, the second probabilistic shaping operation 215-b may shape the second bit stream 202-b to generate a second non-uniform bit stream 220-b as an output.

Comparatively, in accordance with a second implementation of 2-bit shaping, a single shaper (e.g., a single probabilistic shaping operation 215) may be used to shape two separate bit levels (e.g., a₁ and b₁). For example, a single channel code-based shaper may be used to jointly shape the two bit levels a₁ and b₁. In some implementations, the log-likelihood ratios (LLRs) for the channel code-based shaper may be initialized according to a corresponding target probability distribution. In some aspects, the target probability distribution may be the same or different for the two respective bit levels a₁ and b₁.

For example, in the context of 2-bit shaping, a Tx device may target a distribution Pr(a₁=0)=0.8, and Pr(b₁=0)=0.3, resulting in a probability distribution of 0.24, 0.56, 0.06, and 0.14 for constellation points “00,” “01,” “10,” and “11,” respectively. An example of such a probability distribution is illustrated in the first constellation configuration 270-a of FIG. 2, where the height of the lines illustrates the relative probabilities that the respective constellation points may be used (e.g., 0.56 probability for “01,” 0.24 probability for “00,” 0.14 probability for “10,” and 0.06 probability for “11”).

As shown in the first constellation configuration 270-a in FIG. 2, this example 2-bit shaping results in a distribution is non-monotonic when the bits are mapped to the respective constellation points according to a Gray mapping (e.g., Gray mapping where successive constellation points differ by only one bit). The probability distribution is non-monotonic in that the slope of a theoretical line connecting the peaks of the respective probability lines would change sign (e.g., slope is negative from “01” to “00” to “10,” but then positive to “11”). In other words, the probability distribution shown in the first constellation configuration 270-a is non-monotonic in that the probability of the constellation point “11” further from the origin is greater than the probability of the constellation point “10” that is closer to the origin. Comparatively, for a monotonic probability distribution (such as the monotonic probability distribution illustrated in the second constellation configuration 270-b), a slope of a theoretical line connecting the peaks of respective probability lines does not change sign (e.g., decreasing probability across all constellation points).

For the purposes of the present disclosure, a constellation configuration may exhibit monotonicity (e.g., a monotonic probability distribution) if the probability associated with a constellation point (e.g., a modulation constellation) is monotonically reducing as a function of distance of the respective constellation point to the origin. In order to achieve the best performance at the Tx device when transmitting messages, larger probabilities are assigned to constellation points that are closer to the origin, and smaller probabilities are assigned to constellation points that are further away from the origin.

As noted previously herein, constellation points further from the origin may require more transmit energy as compared to points closer to the origin, meaning the non-monotonic probability distribution illustrated in the first constellation configuration 270-a may be less energy efficient as compared to a monotonic probability distribution (such as the second constellation configuration 270-b). As such, conventional techniques that utilize non-uniform bit streams 220 that exhibit the probability distribution shown by the first constellation configuration 270-a as inputs to the FEC procedure 240 may not perform well in terms of shaping gain, as the constellation points further from the origin (e.g., constellation points with larger amplitude, or higher Tx power requirements) are used with higher probability as compared to constellation points closer to the origin.

One solution to this problem with conventional multi-bit shaping techniques is to use a non-Gray mapping after probabilistic shaping. For example, swapping the constellation points “10” and “11” and corresponding probabilities would result in a monotonic probability distribution, but a non-Gray mapping. In particular, the mapping would be non-Gray in that performing the swap would result in points “00” and “11” being next to each other (both bits changed between sequential points=non-Gray). While such a swap would result in a monotonic probability distribution, which is good for shaping purposes, the resulting non-Gray mapping may exhibit poor modulation performance when used with bi-interleaved coded modulation (BICM) demodulation and decoding for wireless communications.

In other words, Gray mappings exhibit better improved demodulation performance (e.g., reduced bit error rate) as compared to non-Gray mappings. For example, referring to the Gray mapping illustrated in the first constellation configuration 270-a, if an Rx device receives a constellation point between points “00” and “10,” improperly decoding the constellation point would result in only one bit being misinterpreted due to the Gray mapping (e.g., the first bit would be improperly interpreted as “1” instead of “0,” or vice versa). Comparatively, consider the same example in which points “10” and “11” are swapped. In this example, if an Rx device receives a constellation point between points “00” and “11,” improperly decoding the constellation point would result in two bits being misinterpreted due to the non-Gray mapping (e.g., both the first and second bits would be improperly interpreted).

Accordingly, aspects of the present disclosure are directed to modulation techniques that utilize bit-level shaping to achieve the benefits of both (1) non-Gray mappings for shaping purposes, and (2) Gray mapping for communications purposes (for improved communication/demodulation performance). In particular, aspects of the present disclosure are directed to modulation techniques (e.g., modulation scheme 200 illustrated in FIG. 2) that use bit-level shaping (e.g., probabilistic shaping operation 215) to shape bit streams according to non-Gray mappings, and bit transformations 230 that transform the non-Gray mapping to Gray mapping for communicating messages 265 from a Tx device to an Rx device.

For example, referring to the modulation scheme 200, a Tx device may identify a data payload 210 that is to be communicated to an Rx device, and may apply a probabilistic shaping operation 215 to the data payload 210 to generate two (or more) bit streams 220 (e.g., bit streams 220-a, 220-b) of non-uniformly distributed bits ai and bᵢ (e.g., aᵢ=a₀, a₁, . . . aₖ₋₁; bᵢ=b₀, b₁, . . . , bₖ₋₁). The bits of the non-uniformly distributed bit streams 220 may exhibit empirical distributions that are independently distributed. In other words (e.g., Pr(aᵢ,bᵢ)=Pr(aᵢ)*Pr(bᵢ)). As noted previously herein, the Tx device may be configured to apply a single probabilistic shaping operation 215 to generate the two (or more) respective bit streams, or may apply multiple separate probabilistic shaping operations 215 to generate the two (or more) respective bit streams.

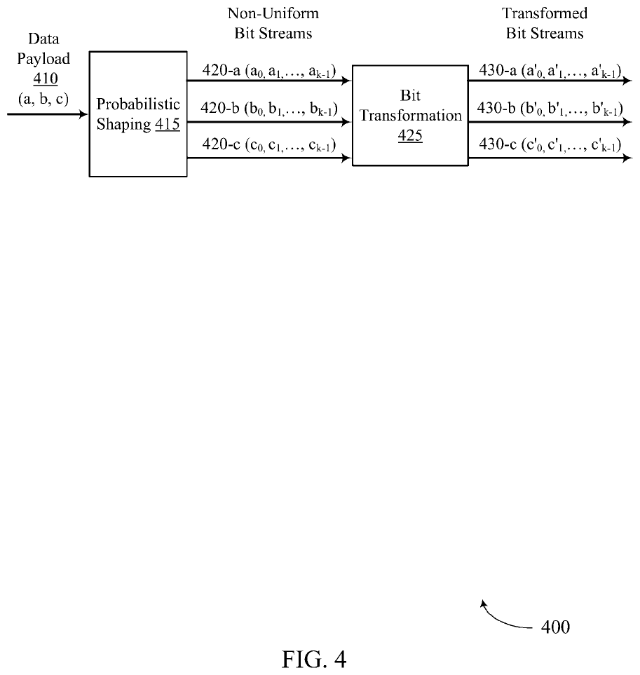

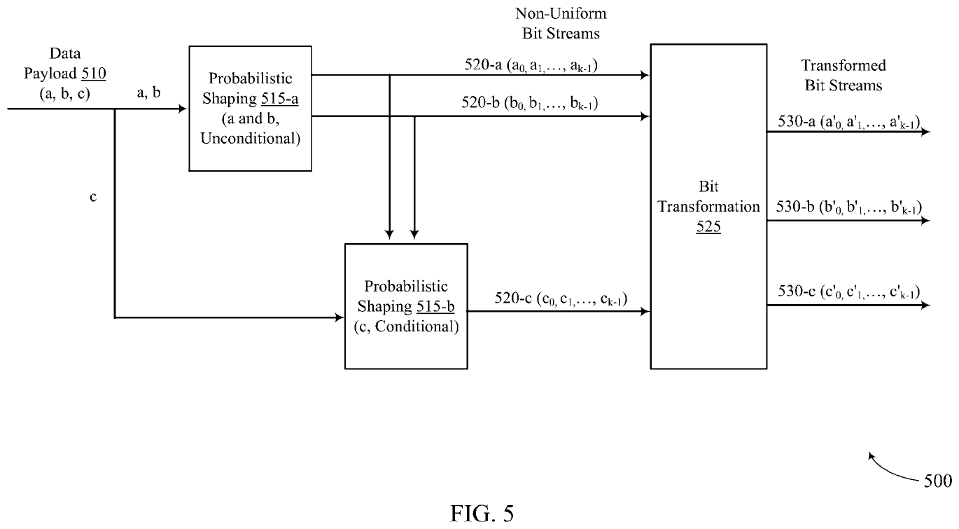

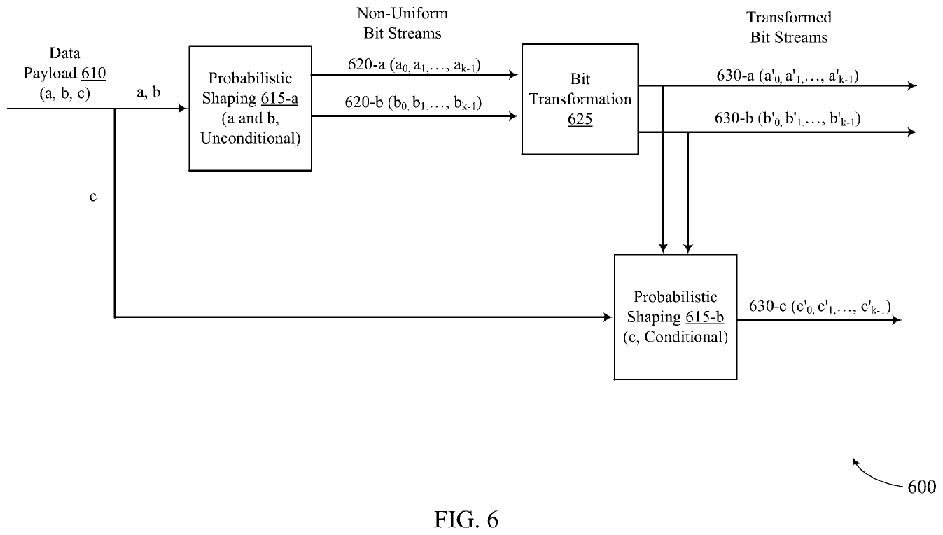

In some aspects, the probabilistic shaping operation 215 may include an unconditional probabilistic shaping operation or a conditional probabilistic shaping operation. In the context of unconditional shaping, the multiple different bit streams 220 may be shaped in parallel, resulting in each bit stream having an independent distribution. Another example of unconditional shaping will be further shown and described with reference to FIG. 4. Comparatively, in the context of conditional shaping, one bit stream 220 may be shaped first according to a target distribution, where other bit streams 220 are shaped according to a conditional distribution (e.g., dependent, or based on, the shaped bits of the first bit stream). Examples of conditional shaping will be further shown and described with reference to FIGS. 5 and 6.

As shown in the first constellation configuration 270-a in FIG. 2, and as described previously herein, the bit streams 220-a, 220-b may exhibit non-monotonic probability distributions if the respective bit streams 220 were mapped to a modulation constellation in accordance with a Gray mapping.

Accordingly, in some implementations, Tx devices described herein may utilize a probabilistic shaper (e.g., probabilistic shaping operation 215) to target non-Gray mappings, and use a bit transform (e.g., bit transformation 230) to map non-Gray mapped signals to Gray mapped signals. In some aspects, the bit transformation 230 may include a linear transformation, an affine transformation, and the like. Moreover, in some aspects, the bit transformation 230 may exhibit a one-to-one mapping between the bit streams 220 and the transformed bit streams 235 so that the bit transformation 230 is invertible (e.g., so that the Rx device can reverse or un-do the bit transformation 230).

For example, continuing with reference to FIG. 2, the Tx device may apply a bit transformation 230 to the two or more bit streams 220 (e.g., bit streams 220-a and 220-b for bit streams aᵢ and bᵢ, respectively) to generate corresponding transformed bit streams 235-a, 235-b indicated by a′ᵢ and b′ᵢ, respectively (e.g., a′ᵢ=a′₀, a′₁, . . . a′ₖ₋₁; b′ᵢ=b′₀, b′₁, . . . b′ₖ₋₁). In some aspects, the two (or more) transformed bit streams 220 after application of the bit transformation 230 may not be conditionally independent relative to one another (e.g., Pr(a′ᵢ, b′ᵢ)≠Pr(a′ᵢ)*Pr(b′ᵢ)).

The bit transformation 230 may include a linear bit transformation procedure. For example, in some cases, the bit transformation 230 may be applied such that

$${a}_{i}^{′} = {a}_{i} and {b}_{i}^{′} = {a}_{i} + {b}_{i} .$$

Comparatively, by way of another example, the bit transformation 230 may be applied such that

$${a}_{i}^{′} = {a}_{i} and {b}_{i}^{′} = {a}_{i} + {b}_{i} + 1.$$

Subsequently, the Tx device may apply an FEC procedure 240 (e.g., high-rate systematic FEC) to the transformed bit streams 235. Moreover, as shown in FIG. 2, the Tx device may also apply the FEC procedure 240 to a uniform bit stream 225 of uniformly distributed bits. In this regard, the Tx device may not apply the bit transformation 230 to the uniform bit stream 225, such that the FEC procedure 240 is applied to the uniform bit stream 225 without application of the bit transformation 230 to the uniform bit stream 225. The FEC procedure 240 may be applied to generate shaped systematic bits 245, unshaped systematic bits 250, and parity bits 255. The shaped systematic bits 245 and the unshaped systematic bits 250 may correspond to the transformed bit streams 235 and the uniform bit stream 225, respectively, where the parity bits 255 may be added during the FEC procedure 240.

Subsequently, the Tx device may modulate (e.g., modulation procedure 260) the respective bits to a modulation constellation using Gray mapping to generate a message 265 that may be transmitted to the Rx device. In other words, the transformed bit streams 235 may be modulated to points of a modulation constellation using a Gray mapping, where each transformed bit stream 235 maps to a particular bit location of the modulation constellation. Specifically, during the modulation procedure 260 (e.g., QAM modulation procedure), the shaped systematic bits 245 may be mapped to the amplitude of points of a modulation constellation, where the unshaped systematic bits 250 and the parity bits 255 may be mapped to the sign of the points of the modulation constellation.

As shown in the second constellation configuration 270-b in FIG. 2, by applying the bit transformation 230, the transformed bit streams 235 may exhibit monotonic distributions when the respective transformed bit streams 235 are mapped to the modulation constellation in accordance with a Gray mapping (e.g., probability distribution of the transformed symbols/constellation points is monotonically decreasing with amplitude moving away from the origin). In other words, following application of the bit transformation 230, the transformed bit streams 235 (e.g., transformed bit streams 235-a and 235-b for

$${a}_{i}^{′} and {b}_{i}^{′} ,$$

respectively) may be modulated according to a Gray mapping to achieve improved demodulation performance. As such, by pairing the bit transformation 230 with the probabilistic shaping operation 215, techniques described herein may enable Tx devices to utilize non-Gray mappings for shaping purposes, while simultaneously achieving monotonic probability distributions utilizing Gray mappings for communication purposes.

Upon receiving the message 265, the Rx device may effectively perform the steps of the modulation scheme 200 in reverse to demodulate, retrieve, and process the data payload 210. For example, the Rx device may receive the message 265, demodulate the message 265 by mapping the constellation to bits of the transformed bit streams 235 (e.g., inverse of modulation procedure 260), apply a bit transformation (e.g., inverse of bit transformation 230) to convert the transformed bit streams 235 to non-uniformly distributed bit streams 220, and apply a reverse probabilistic distribution operation (e.g., inverse of probabilistic shaping operation 215) to retrieve and process the data payload 210.

In some aspects, the Tx and Rx device may exchange signaling and information with one another regarding the modulation scheme 200. In particular, the Tx device may indicate, to the Rx device, information about the probabilistic shaping operation 215, the bit transformation 230, and the like. That is, the shaping parameters/configurations used by the Tx device may be communicated to Rx device, or may be otherwise pre-agreed between the Tx and the Rx devices. Such parameters may be either hard-coded in relevant standards associated with the network, or configured/signaled according to one of a set of configurations.

Information or parameters that may be indicated to the Rx device (or pre-agreed between the respective devices) may include a quantity of bits that are shaped by the probabilistic shaping operation 215, whether the Tx device applies unconditional or conditional shaping (or both) (as will be shown and described in FIGS. 5-6), information regarding how each bit stream 220 is shaped (e.g., conditional vs unconditional), a shaping distribution of the probabilistic shaping operation 215, a shaping rate for each bit/bit stream 220, information associated with the bit transformation 230 used by the Tx device, relative orderings between conditional/unconditional probabilistic shaping operations 215 and the bit transformation 230, or any combination thereof.

While the modulation scheme 200 shown and described in FIG. 2 is primarily described in the context of two bit streams (e.g., and bᵢ), this is not to be regarded as a limitation of the present disclosure, unless noted otherwise herein. In particular, aspects of the present disclosure may be applied in the context of more than two bit streams, as will be shown and described in further detail with respect to FIGS. 4-6. Further, aspects of the present disclosure may also be applied with compression-based shaping (e.g., CCDM) or channel coding-based shaping, as long as the shaping is done on the bit level rather than the symbol level.

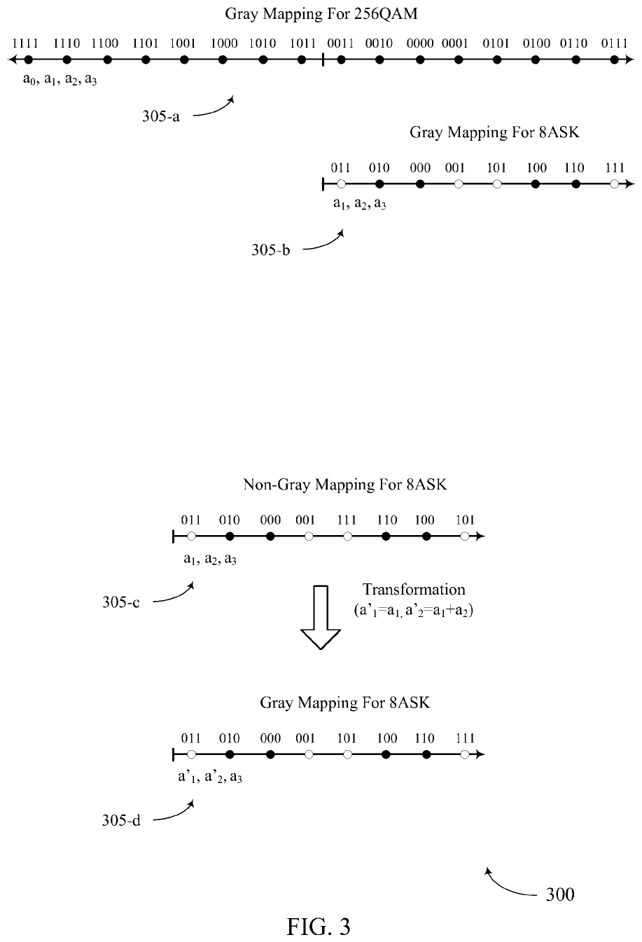

FIG. 3 shows an example of constellation configurations 300 that support bit-level probabilistic shaping for wireless communications in accordance with one or more aspects of the present disclosure. Aspects of the constellation configurations 300 may implement, or be implemented by, aspects of wireless communications system 100, the modulation scheme 200, or both. In particular, the constellation configuration 300 illustrates an example transform that may be applied by the modulation scheme 200 for 2-bit shaping with 256 QAM.

The first configuration 305-a shown in FIG. 3 illustrates a modulation constellation that utilizes a Gray mapping for 256 QAM for bits (e.g., bit streams) a₀, a₁, a₂, and a₃. In one example, suppose the Tx device is to shape the bit streams a₁ and a₂, and will leave bit streams a₀ and a₃ unshaped. In such a case, a probabilistic shaping operation and subsequent bit transformation (as described in FIG. 2) may result in the second configuration 305-b. Through the shaping and subsequent bit transformation described herein, the sign bit a₀ may be dropped. Moreover, from the second configuration 305-b, it may be seen that the bits a₁ and a₂ are still Gray mapped, conditioned on a₃=0 or a₃=1 (as shown by the hollow or un-filled constellation points for “001,” “001,” “101,” and “111” for a₃=1).

In other words, the bit transformation (e.g., bit transformation 230 in FIG. 2) may be independent of a₃ (the LSB mapping to the modulation constellation). However, it is noted herein that a different distribution may be used on a₁ and a₂ conditional on the value of a₃ for conditional shaping, as will be described in further detail herein with respect to FIGS. 5-6. In this case shown in FIG. 3, the probability distribution on the bits a₁ and a₂ (pre-transformation) may be conditionally independent given a₃ (however, the bits a₁ and a₂ are not independent without the conditioning). Additionally, the transformed bits a₁′, a₂′ are not independent/conditionally independent.

The transformation of the bit streams a₁, a₂, and a₃ may be further illustrated with reference to the third configuration 305-c and the fourth configuration 305-d. In particular, the third configuration 305-c illustrates a non-Gray mapping for 8ASK, which may be used for shaping (non-Gray in that adjacent bits differ by more than one bit value, such as “001” and “111”). As such, the third configuration 305-c may illustrate a configuration of the non-uniform bit streams 220 illustrated in FIG. 2. Subsequently, application of a bit transformation (e.g., bit transformation 230 where a′₁=a₁ and a′₂=a₁+a₂) results in the fourth configuration 305-d illustrating a Gray mapping for 8ASK that is used for communications.

FIG. 4 shows an example of a modulation scheme 400 that supports bit-level probabilistic shaping for wireless communications in accordance with one or more aspects of the present disclosure. Aspects of the modulation scheme 400 may implement, or be implemented by, aspects of the wireless communications system 100, the modulation scheme 200, the constellation configuration 300, or any combination thereof. For example, the modulation scheme 400 illustrates an example of 3-bit shaping for 256 QAM.

In particular, the modulation scheme 400 illustrates an example where a probabilistic shaping operation and subsequent bit transformation is applied to three separate bit streams. In this regard, the modulation scheme 400 illustrates an example or iteration of the modulation scheme 200 depicted in FIG. 2. As such, any description associated with the modulation scheme 200 illustrated in FIG. 2 may be regarded as applying to the modulation scheme 400 illustrated in FIG. 4, to the extent applicable.

As described previously herein, a Tx device may identify a data payload 410 that is to be communicated to an Rx device, and may apply a probabilistic shaping operation 415 to the data payload 410 to generate three separate bit streams 420 (e.g., bit streams 420-a, 420-b, 420-c) of non-uniformly distributed bits aᵢ, bᵢ, and cᵢ (e.g., aᵢ=a₀, a₁, . . . , aₖ₋₁, bᵢ=b₀, b₁, . . . , b^{k-1}, cᵢ=c₀, c₁, . . . , cₖ₋₁). As shown and described with respect to the first constellation configuration 270-a illustrated in FIG. 2, the bit streams 420 may exhibit a non-monotonic probability distribution if the bit streams 420 were mapped to a modulation constellation according to a Gray mapping.

As such, the Tx device may apply a bit transformation 425 to the three respective bit streams 420 to generate corresponding transformed bit streams 430-a, 430-b, and 430-c for transformed bit streams indicated by a′ᵢ, b′ᵢ, and c′ᵢ, respectively (e.g., a′ᵢ=a′₀, a′₁, . . . , a′ₖ₋₁; b′ᵢ=b′₀, b′₁, . . . , b′ₖ₋₁, c′ᵢ=c′₀, c′₁, . . . , c′ₖ₋₁). For example, in some cases, the Tx device may apply the bit transformation 425 such that a′ᵢ=aᵢ, b′ᵢ=aᵢ+bᵢ, and c′ᵢ=1+aᵢ+bᵢ+cᵢ (though additional and/or alternative transformations may be used). As described with reference to FIG. 2, the Tx device may apply an FEC procedure to the transformed bit streams 430, and subsequently modulate the bit streams to a modulation constellation to generate a message that may be communicated to the Rx device. Further, as shown and described with respect to the second constellation configuration 270-b illustrated in FIG. 2, the transformed bit streams 430 may exhibit a monotonic distribution when the transformed bit streams 430 are mapped to the modulation constellation according to a Gray mapping.

The modulation schemes 200 and 400 described herein have largely been described in the context of unconditional shaping, in which the respective bit streams from the shaper are shaped in parallel, resulting in each bit stream having independent distribution. In additional or alternative implementations, a Tx device may be configured to perform “conditional shaping” where one bit stream is shaped first according to a target distribution, and other bit streams are shaped according to a conditional distribution (dependent on the bits in the first bit stream).

For example, in the context of a data payload including bits a₁ and a₂, assume a Tx device is configured to achieve a (joint) distribution for Pr(a₁, a₂), where the two bits are not independent (e.g., the distribution can not be factorized as Pr(a₁)*Pr(a₂)). In this example, with bit-level shaping techniques described herein, the Tx device may shape the first bit stream a₁ according to a target distribution Pr(a₁). Subsequently, the Tx device may shape the second bit stream a₂ according to two distributions Pr(a₂|a₁=0) and Pr(a₂|a₁==1), depending on whether the first bit stream a₁ is 0 or 1. In other words, the second bit stream a₂ may be based on (e.g., conditional on) the shaping of the first bit stream a₁. In this example, the resulting distribution will be Pr(a₁)*Pr(a₂|a₁)=Pr(a₁, a₂) according to definition of joint probability. In general, unconditional shaping may result in a “stair step” distribution, where conditional shaping may result in a “bell curve” distribution.

Examples of conditional shaping may be further shown and described with reference to FIGS. 5 and 6.

FIG. 5 shows an example of a modulation scheme 500 that supports bit-level probabilistic shaping for wireless communications in accordance with one or more aspects of the present disclosure. Aspects of the modulation scheme 500 may implement, or be implemented by, aspects of the wireless communications system 100, the modulation scheme 200, the constellation configuration 300, the modulation scheme 400, or any combination thereof. For example, the modulation scheme 500 illustrates an example of conditional shaping.

In particular, the modulation scheme 500 illustrates an example where conditional shaping (and a bit transformation) is applied to three separate bit streams. That is, modulation scheme 500 illustrates an example where a Tx device first performs conditional shaping for three separate bit streams, then performs a bit transformation on all the shaped bit streams. In this regard, the modulation scheme 500 illustrates an iteration of the modulation scheme 200 depicted in FIG. 2. As such, any description associated with the modulation scheme 200 illustrated in FIG. 2 may be regarded as applying to the modulation scheme 500 illustrated in FIG. 5, to the extent applicable.

As described previously herein, a Tx device may identify a data payload 510 that is to be communicated to an Rx device including three separate bits or bit streams dᵢ, bᵢ, and cᵢ. The Tx device may apply a first, unconditional probabilistic shaping operation 515-a to the data payload 510 to generate two separate bit streams 520 (e.g., bit streams 520-a, 520-b) of non-uniformly distributed bits aᵢ and bᵢ (e.g., aᵢ=a₀, a₁, . . . , aₖ₋₁; bᵢ=b₀, b₁, . . . , bₖ₋₁). The Tx device may apply the first probabilistic shaping operation 515-a according to an unconditional distribution Pr(aᵢ, bᵢ). The Tx device may perform a second, conditional probabilistic shaping operation 515-b to generate a third bit stream 520-c for cᵢ (e.g., cᵢ=c₀, c₁, . . . , cₖ₋₁). That is, the shaping of the third bit stream 520-c may be dependent on (e.g., conditional on) the shaping of the first two bit streams 520-a, 520-b. Subsequently, the Tx device may apply a bit transformation 525 to the three respective shaped bit streams 520-a, 520-b, and 520-c to generate three respective transformed bit streams 530-a, 530-b, and 530-c.

As described with reference to FIG. 2, the Tx device may apply an FEC procedure to the transformed bit streams 530, and subsequently modulate the bit streams to a modulation constellation to generate a message that may be communicated to the Rx device. Further, as shown and described with respect to the second constellation configuration 270-b illustrated in FIG. 2, the transformed bit streams 530 may exhibit a monotonic distribution when the transformed bit streams 530 are mapped to the modulation constellation according to a Gray mapping.

FIG. 6 shows an example of a modulation scheme 600 that supports bit-level probabilistic shaping for wireless communications in accordance with one or more aspects of the present disclosure. Aspects of the modulation scheme 600 may implement, or be implemented by, aspects of the wireless communications system 100, the modulation scheme 200, the constellation configuration 300, the modulation scheme 400, the modulation scheme 500, or any combination thereof. For example, the modulation scheme 600 illustrates an example of conditional shaping.

In particular, the modulation scheme 600 illustrates an example where conditional shaping (and a bit transformation) is applied to three separate bit streams.

That is, modulation scheme 600 illustrates an example where a Tx device first performs a bit transformation on a subset of unconditionally shaped bit streams, then performs conditional shaping on an additional bit stream based on the unconditionally shaped and transformed bit streams. In this regard, the modulation scheme 600 illustrates an iteration of the modulation scheme 200 depicted in FIG. 2. As such, any description associated with the modulation scheme 200 illustrated in FIG. 2 may be regarded as applying to the modulation scheme 600 illustrated in FIG. 6, to the extent applicable.

As described previously herein, a Tx device may identify a data payload 610 that is to be communicated to an Rx device including three separate bits or bit streams aᵢ, bᵢ, and cᵢ. The Tx device may apply a first, unconditional probabilistic shaping operation 615-a to the data payload 510 to generate two separate bit streams 620 (e.g., bit streams 620-a, 620-b) of non-uniformly distributed bits aᵢ and bᵢ (e.g., aᵢ=a₀, a₁, . . . , aₖ₋₁; bᵢ=b₀, b₁, . . . , bₖ₋₁). The Tx device may apply the first probabilistic shaping operation 615-a according to an unconditional distribution Pr(aᵢ, bᵢ).

Subsequently, the Tx device may apply a bit transformation 625 to the two unconditionally-shaped bit streams 620-a and 620-b to generate two respective transformed bit streams 630-a and 630-b. The Tx device may perform a second, conditional probabilistic shaping operation 615-b to generate a third transformed bit stream 630-c for c′ᵢ (e.g., c′ᵢ=c′₀, c′₁, . . . , c′ₖ₋₁;). That is, the shaping of the third bit stream 630-c may be dependent on (e.g., conditional on) the shaping and transformation of the first two bit streams 620-a, 620-b. Note that, in this case, there may be no need to perform bit transformation on the third bit stream c′ᵢ, since the bit dependencies are already captured in the conditional shaping.

As described with reference to FIG. 2, the Tx device may apply an FEC procedure to the transformed bit streams 630, and subsequently modulate the bit streams to a modulation constellation to generate a message that may be communicated to the Rx device. Further, as shown and described with respect to the second constellation configuration 270-b illustrated in FIG. 2, the transformed bit streams 630 may exhibit a monotonic distribution when the transformed bit streams 630 are mapped to the modulation constellation according to a Gray mapping.

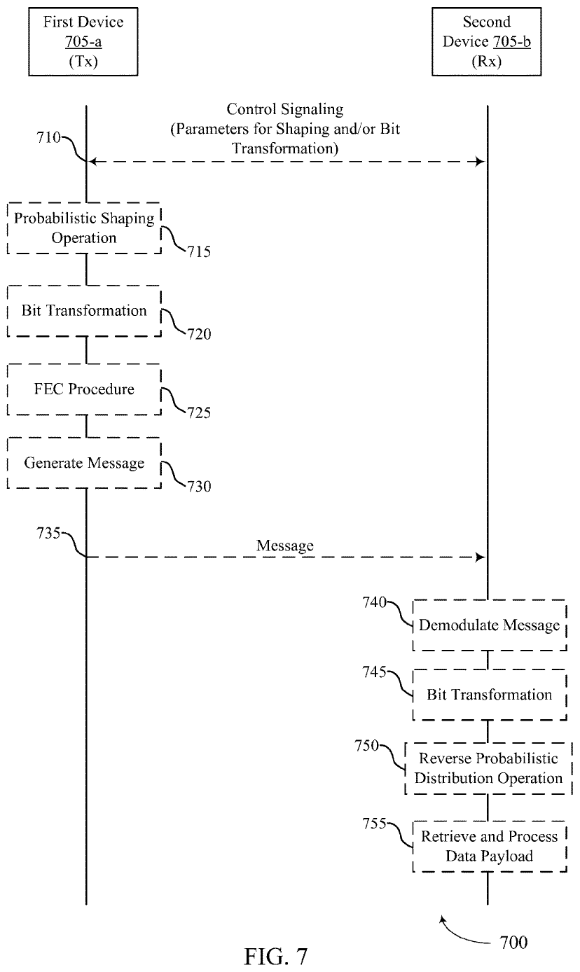

FIG. 7 shows an example of a process flow 700 that supports bit-level probabilistic shaping for wireless communications in accordance with one or more aspects of the present disclosure. Aspects of the process flow 700 may implement, or be implemented by, aspects of the wireless communications system 100, the modulation scheme 200, the constellation configuration 300, the modulation scheme 400, the modulation scheme 500, the modulation scheme 600, or any combination thereof. For example, the process flow 700 illustrates operations and communication procedures performed by a Tx device to perform bit-level probabilistic shaping for messages communicated to an Rx device, as well as operations and procedures performed by the Rx device to retrieve the data payload of a received message.

The process flow 700 includes a first wireless device 705-a (e.g., Tx device) and a second wireless device 705-b (e.g., Rx device), which may be examples of UEs 115, network entities 105, and other wireless devices as described herein. For example, the first wireless device 705-a may be an example of a network entity 105, and the second wireless device 705-b may be an example of a UE 115 (or vice versa). By way of another example, the first wireless device 705-a may be an example of a first UE 115, and the second wireless device 705-b may be an example of a second UE 115.

In some examples, the operations illustrated in process flow 700 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 710, the first wireless device 705-a may communicate control signaling with the second wireless device 705-b, where the control signaling indicates one or more parameters associated with probabilistic shaping operations, bit transformations, or both, performed by the first wireless device 705-a to generate messages transmitted to the second wireless device 705-b. For example, the control signaling may indicate parameters associated with the probabilistic shaping operation 215 and/or the bit transformation 230 illustrated in FIG. 2. The control signaling may include an RRC message, DCI message, MAC-CE, system information message, sidelink control information (SCI) message, and the like.

Parameters that may be communicated or indicated between the respective devices may include, but are not limited to, a quantity of bits of a data payload that are shaped according to a probabilistic shaping operation, an indication that a probabilistic shaping operation comprises a conditional shaping operation, an unconditional shaping operation, or both, a relative ordering between a bit transformation and a probabilistic shaping operation, a shaping distribution of the probabilistic shaping operation, a shaping rate of the probabilistic shaping operation, an indication of the bit transformation applied to the two or more bit streams, or any combination thereof.

In additional or alternative implementations, parameters associated with bit transformations and/or probabilistic shaping operations may be pre-agreed by the wireless devices 705, defined by the network, or both. In such cases, the wireless devices 705 may be configured to determine the respective parameters without the explicit control signaling at 710.

At 715, the first wireless device 705-a may apply a probabilistic shaping operation to a data payload to form one or more bit streams of non-uniformly distributed bits. For example, as shown in FIG. 2, the first wireless device 705-a may apply the probabilistic shaping operation 215 to the data payload 210 to generate the bit streams 220-a and 220-b. As such, in some cases, applying the probabilistic shaping operation results in respective first probability distributions corresponding to each of the two or more bit streams being conditionally independent relative to one another. In some implementations, the first wireless device 705-a may apply the probabilistic shaping operation at 715 in accordance with the parameters communicated or determined at 710.

As noted previously herein, the first wireless device 705-a may be configured to apply a single probabilistic shaping operation to generate the two (or more) respective bit streams, or may apply multiple separate probabilistic shaping operations to generate the two (or more) respective bit streams. Moreover, as described previously herein, the probabilistic shaping operation may include an unconditional probabilistic shaping operation or a conditional probabilistic shaping operation. In the context of unconditional shaping, the multiple different bit streams may be shaped in parallel, resulting in each bit stream having an independent distribution, as shown and described in FIG. 4. Comparatively, in the context of conditional shaping, one bit stream 220 may be shaped first according to a target distribution, where other bit streams 220 are shaped according to a conditional distribution (e.g., dependent, or based on, the shaped bits of the first bit stream), as shown and described in FIGS. 5 and 6.

In some cases, as shown in the first constellation configuration 270-a illustrated in FIG. 2, a mapping of the bits from the two or more bit streams across the set of symbols of the modulation constellation in accordance with the Gray mapping would result in a non-monotonic distribution of the bits.

At 720, the first wireless device 705-a may apply a bit transformation to the two or more bit streams in order to generate a corresponding two or more transformed bit streams. In some cases, the bit transformation includes a linear transformation that is configured to convert bit streams associated with a non-Gray mapping to bit streams associated with a Gray mapping. For example, as shown in FIG. 2, the first wireless device 705-a may apply the bit transformation 230 to the two or more bit streams 220 to generate two or more corresponding transformed bit streams 235. In some implementations, the first wireless device 705-a may apply the bit transformation at 720 in accordance with the parameters communicated or determined at 710. Moreover, the first wireless device 705-a may apply the bit transformation at 720 based on performing the probabilistic shaping operation at 715.

At 725, the first wireless device 705-a may apply an FEC procedure to the two or more transformed bit streams. For example, as shown in FIG. 2, the first wireless device 705-a may apply an FEC procedure 240 to the transformed bit streams 235. Moreover, in some cases, the first wireless device 705-a may apply the FEC procedure to the transformed bit streams 235 and to an additional bit stream of uniformly distributed bits (e.g., uniform bit stream 255) that is derived from the data payload 210 without application of the probabilistic shaping operation 215 and/or the bit transformation 230. The first wireless device 705-a may apply the FEC procedure at 725 based on communicating the control signaling at 710, performing the probabilistic shaping operation at 715, performing the bit transformation at 720, or any combination thereof.

While the probabilistic shaping operation, bit transformation, and FEC procedure are shown and described in sequential steps in FIG. 7, this is solely for illustrative purposes. In particular, as described herein, the relative ordering of the probabilistic shaping operation and the bit transformation may change depending on a number of factors, including the quantity of bits to be shaped and transmitted, the type of the probabilistic shaping operation (e.g., conditional, unconditional), and the like. Examples of the relative orderings of the steps of the process flow 700 are shown and described herein with reference to FIGS. 2 and 4-6.

At 730, the first wireless device 705-a may generate a message that includes the data payload to be communicated to the second wireless device 705-b. In particular, the first wireless device 705-a may generate the message by modulating bits from the two or more transformed bit streams to a set of symbols of a modulation constellation in accordance with a Gray mapping. For instance, as shown in FIG. 2, the first wireless device 705-a may generate the message 265 by performing a modulation procedure 260 to modulate bits from the transformed bit streams 235 to symbols of a modulation constellation in accordance with a Gray mapping. As shown in the second constellation configuration 270-b illustrated in FIG. 2, a probability distribution of the set of symbols after the modulating may be monotonic.

The first wireless device 705-a may generate the message at 730 based on communicating the control signaling at 710, performing the probabilistic shaping operation at 715, performing the bit transformation at 720, performing the FEC procedure at 725, or any combination thereof.

At 735, the first wireless device 705-a may transmit the message generated at 730 to the second wireless device 705-b. Moreover, as described herein, the second wireless device 705-b may be configured to effectively perform steps 715-730 of the process flow 730 in reverse (as illustrated by steps 740-755) to retrieve and process the data payload. In such cases, the second wireless device 705-b may be configured to perform steps 740-755 based on (e.g., in accordance with) the parameters indicated via the control signaling at 710. As such, process flow 700 may proceed to step 740.

At 740, the second wireless device 705-b may demodulate the message received at 735 by mapping the set of symbols of the modulation constellation to bits of two or more transformed bit streams in accordance with a Gray mapping. For example, referring to FIG. 2, the second wireless device 705-b may demodulate the received message 265 (e.g., perform the inverse of the modulation procedure 260) to retrieve transformed bit streams 235.

At 745, the second wireless device 705-b may apply a bit transformation to the two or more transformed bit streams in order to generate a corresponding two or more bit streams of non-uniformly distributed bits. For example, referring to FIG. 2, the second wireless device 705-b may apply a bit transformation (e.g., inverse of the bit transformation 230) to the transformed bit streams 235 to generate the bit streams 220 of non-uniformly distributed bits.

At 750, the second wireless device 705-b may apply a reverse probabilistic distribution operation to the two or more bit streams of non-uniformly distributed bits to retrieve a data payload of the message. For example, referring to FIG. 2, the second wireless device 705-b may apply a reverse probabilistic distribution operation (e.g., inverse of probabilistic shaping operation 215) to the bit streams 220 to retrieve the data payload 210 of the received message 265.

At 755, the second wireless device 705-b may retrieve and process the data payload. The second wireless device 705-b may retrieve and process the data payload at 755 based on demodulating the message at 740, applying the bit transformation at 745, applying the reverse probabilistic shaping operation at 750, or any combination thereof.

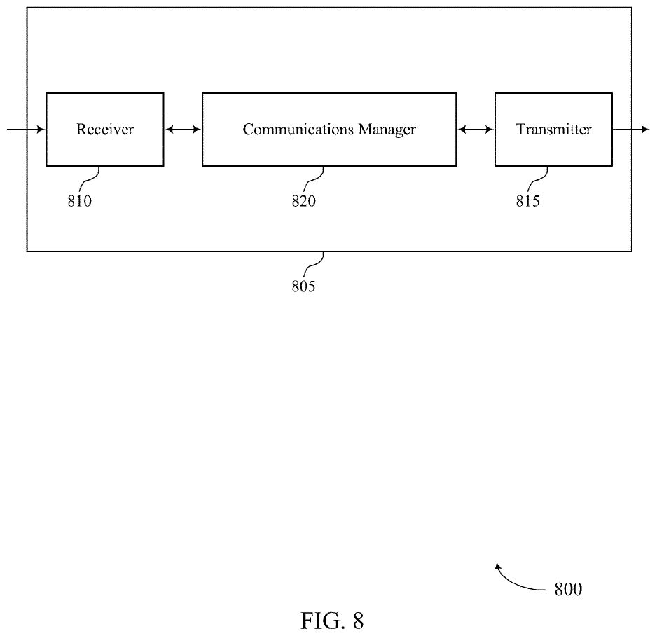

FIG. 8 shows a block diagram 800 of a device 805 that supports bit-level probabilistic shaping for wireless communications in accordance with one or more aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to bit-level probabilistic shaping for wireless communications). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to bit-level probabilistic shaping for wireless communications). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of bit-level probabilistic shaping for wireless communications as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

For example, the communications manager 820 is capable of, configured to, or operable to support a means for applying a probabilistic shaping operation to a data payload to form two or more bit streams of non-uniformly distributed bits. The communications manager 820 is capable of, configured to, or operable to support a means for applying a bit transformation to the two or more bit streams in order to generate a corresponding two or more transformed bit streams. The communications manager 820 is capable of, configured to, or operable to support a means for modulating bits from the two or more transformed bit streams to a set of symbols of a modulation constellation in accordance with a Gray mapping to generate a message including the data payload, where a probability distribution of the set of symbols after the modulation is monotonic. The communications manager 820 is capable of, configured to, or operable to support a means for transmitting the message to a second wireless device.

By including or configuring the communications manager 820 in accordance with examples as described herein, the device 805 (e.g., a processor controlling or otherwise coupled with the receiver 810, the transmitter 815, the communications manager 820, or a combination thereof) may support techniques that enable wireless communications to be performed using bit-level probabilistic shaping along with Gray mappings to achieve monotonic distributions for wireless communications. As such, techniques described herein may enable wireless devices to utilize non-Gray mappings for the purposes of probabilistic shaping, while also taking advantage of Gray mappings for the purpose of communicated messages. In this regard, aspects of the present disclosure may enable more efficient and reliable wireless communications (through the use of Gray mappings), while also reducing Tx powers used to communicate messages between devices (through the use of monotonic probability distributions).

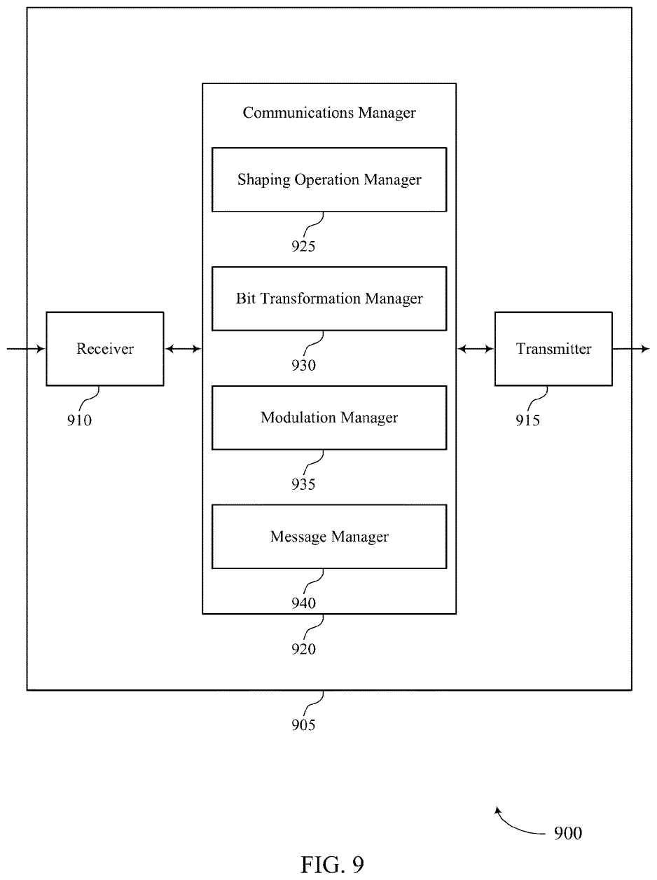

FIG. 9 shows a block diagram 900 of a device 905 that supports bit-level probabilistic shaping for wireless communications in accordance with one or more aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to bit-level probabilistic shaping for wireless communications). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to bit-level probabilistic shaping for wireless communications). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of bit-level probabilistic shaping for wireless communications as described herein. For example, the communications manager 920 may include a shaping operation manager 925, a bit transformation manager 930, a modulation manager 935, a message manager 940, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The shaping operation manager 925 is capable of, configured to, or operable to support a means for applying a probabilistic shaping operation to a data payload to form two or more bit streams of non-uniformly distributed bits. The bit transformation manager 930 is capable of, configured to, or operable to support a means for applying a bit transformation to the two or more bit streams in order to generate a corresponding two or more transformed bit streams. The modulation manager 935 is capable of, configured to, or operable to support a means for modulating bits from the two or more transformed bit streams to a set of symbols of a modulation constellation in accordance with a Gray mapping to generate a message including the data payload, where a probability distribution of the set of symbols after the modulating is monotonic. The message manager 940 is capable of, configured to, or operable to support a means for transmitting the message to a second wireless device.

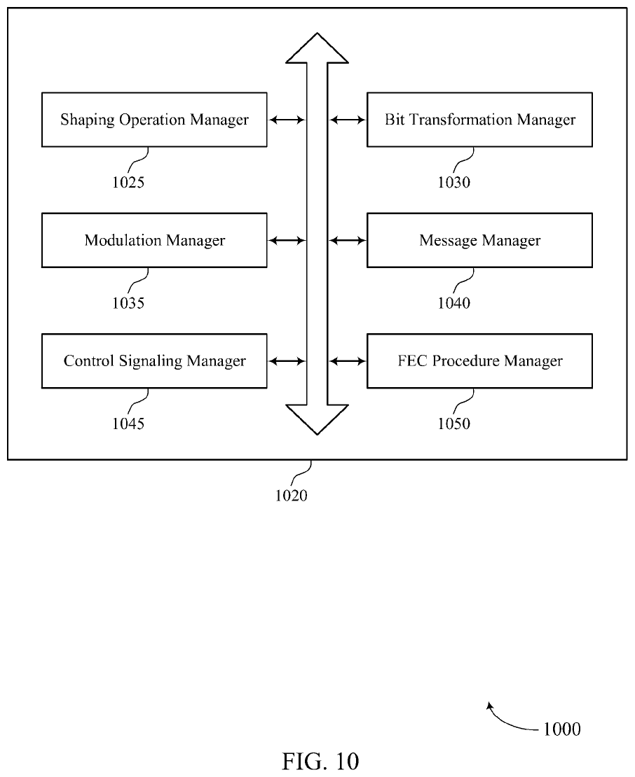

FIG. 10 shows a block diagram 1000 of a communications manager 1020 that supports bit-level probabilistic shaping for wireless communications in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of bit-level probabilistic shaping for wireless communications as described herein. For example, the communications manager 1020 may include a shaping operation manager 1025, a bit transformation manager 1030, a modulation manager 1035, a message manager 1040, a control signaling manager 1045, an FEC procedure manager 1050, or any combination thereof. Each of these components may communicate, directly or indirectly, with one another (e.g., via one or more buses).

The shaping operation manager 1025 is capable of, configured to, or operable to support a means for applying a probabilistic shaping operation to a data payload to form two or more bit streams of non-uniformly distributed bits. The bit transformation manager 1030 is capable of, configured to, or operable to support a means for applying a bit transformation to the two or more bit streams in order to generate a corresponding two or more transformed bit streams. The modulation manager 1035 is capable of, configured to, or operable to support a means for modulating bits from the two or more transformed bit streams to a set of symbols of a modulation constellation in accordance with a Gray mapping to generate a message including the data payload, where a probability distribution of the set of symbols after the modulation is monotonic. The message manager 1040 is capable of, configured to, or operable to support a means for transmitting the message to a second wireless device.

In some examples, the control signaling manager 1045 is capable of, configured to, or operable to support a means for communicating, with the second wireless device, control signaling that indicates one or more parameters associated with the probabilistic shaping operation, the bit transformation, or both, where application of at least one of the probabilistic shaping operation or the bit transformation is performed in accordance with the one or more parameters.

In some examples, the one or more parameters include a quantity of bits of the data payload that are shaped according to the probabilistic shaping operation, an indication that the probabilistic shaping operation includes a conditional shaping operation, an unconditional shaping operation, or both, a relative ordering between the bit transformation and the probabilistic shaping operation, a shaping distribution of the probabilistic shaping operation, a shaping rate of the probabilistic shaping operation, an indication of the bit transformation applied to the two or more bit streams, or any combination thereof.

In some examples, a mapping of the bits from the two or more bit streams across the set of symbols of the modulation constellation in accordance with the Gray mapping would result in a non-monotonic probability distribution of the set of symbols.

In some examples, applying the probabilistic shaping operation results in respective first probability distributions corresponding to each of the two or more bit streams being conditionally independent relative to one another. In some examples, applying the bit transformation results in respective second probability distributions corresponding to each of the two or more transformed bit streams being not conditionally independent relative to one another.

In some examples, the FEC procedure manager 1050 is capable of, configured to, or operable to support a means for applying an FEC procedure to the two or more transformed bit streams and to an additional bit stream of uniformly distributed bits, where the additional bit stream is derived from the data payload without application of the probabilistic shaping operation or the bit transformation, and where modulating the bits of the two or more transformed bit streams is performed based on applying the FEC procedure.

In some examples, the probabilistic shaping operation includes a conditional shaping operation. In some examples, probabilistic shaping of the two or more bit streams is conditional on the additional bit stream.

In some examples, to support applying the probabilistic shaping operation, the shaping operation manager 1025 is capable of, configured to, or operable to support a means for applying the probabilistic shaping operation in parallel to form the two or more bit streams of non-uniformly distributed bits based on the probabilistic shaping operation including the unconditional shaping operation.

In some examples, to support applying the probabilistic shaping operation, the shaping operation manager 1025 is capable of, configured to, or operable to support a means for applying the first shaping operation to form the first bit stream of non-uniformly distributed bits. In some examples, to support applying the probabilistic shaping operation, the shaping operation manager 1025 is capable of, configured to, or operable to support a means for applying the second shaping operation to form the second bit stream of non-uniformly distributed bits based on shaping the first bit stream, and based on the probabilistic shaping operation including the conditional shaping operation.

In some examples, the shaping operation manager 1025 is capable of, configured to, or operable to support a means for applying the first shaping operation in accordance with a target distribution to form the first bit stream of non-uniformly distributed bits, where application of the second shaping operation is conditional on the first bit stream.

In some examples, the shaping operation manager 1025 is capable of, configured to, or operable to support a means for applying an additional probabilistic shaping operation to form a third bit stream of non-uniformly distributed bits, where application of the additional probabilistic shaping operation is conditional on the two or more bit streams or the two or more transformed bit streams. In some examples, the bit transformation manager 1030 is capable of, configured to, or operable to support a means for applying the bit transformation to the third bit stream to generate a third transformed bit stream corresponding to the third bit stream, where modulating the bits of the two or more transformed bit streams is based on mapping the third transformed bit stream to the modulation constellation.

In some examples, the bit transformation includes a linear transformation that is configured to convert bit streams associated with a non-Gray mapping to bit streams associated with a Gray mapping.

In some examples, the two or more bit streams include a first bit stream and a second bit stream associated with non-Gray mappings. In some examples, the linear transformation is configured to transform the first bit stream to a first transformed bit stream associated with a Gray mapping, and transform a combination of the first bit stream and the second bit stream to a second transformed bit stream associated with a second Gray mapping.

In some examples, the probability distribution of the set of symbols after the modulating is monotonic such that symbols of the modulation constellation with lower magnitudes or transmit powers are associated with a higher distribution probability as compared to symbols with higher magnitudes or transmit powers.

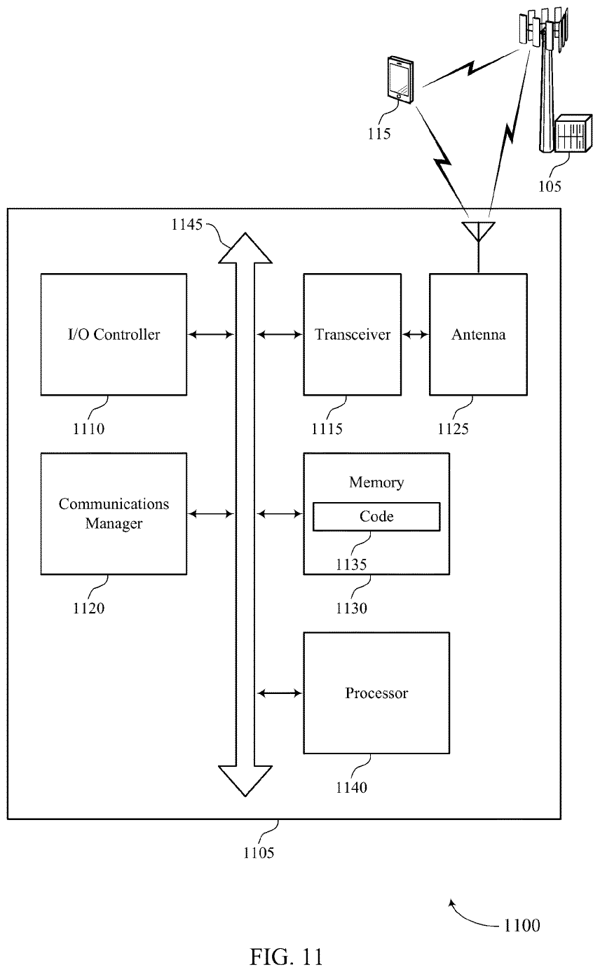

FIG. 11 shows a diagram of a system 1100 including a device 1105 that supports bit-level probabilistic shaping for wireless communications in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting bit-level probabilistic shaping for wireless communications). For example, the device 1105 or a component of the device 1105 may include a processor 1140 and memory 1130 coupled with or to the processor 1140, the processor 1140 and memory 1130 configured to perform various functions described herein.

For example, the communications manager 1120 is capable of, configured to, or operable to support a means for applying a probabilistic shaping operation to a data payload to form two or more bit streams of non-uniformly distributed bits. The communications manager 1120 is capable of, configured to, or operable to support a means for applying a bit transformation to the two or more bit streams in order to generate a corresponding two or more transformed bit streams. The communications manager 1120 is capable of, configured to, or operable to support a means for modulating bits from the two or more transformed bit streams to a set of symbols of a modulation constellation in accordance with a Gray mapping to generate a message including the data payload, where a probability distribution of the set of symbols after the modulating is monotonic. The communications manager 1120 is capable of, configured to, or operable to support a means for transmitting the message to a second wireless device.

By including or configuring the communications manager 1120 in accordance with examples as described herein, the device 1105 may support techniques that enable wireless communications to be performed using bit-level probabilistic shaping along with Gray mappings to achieve monotonic distributions for wireless communications. As such, techniques described herein may enable wireless devices to utilize non-Gray mappings for the purposes of probabilistic shaping, while also taking advantage of Gray mappings for the purpose of communicated messages. In this regard, aspects of the present disclosure may enable more efficient and reliable wireless communications (through the use of Gray mappings), while also reducing Tx powers used to communicate messages between devices (through the use of monotonic probability distributions).

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of bit-level probabilistic shaping for wireless communications as described herein, or the processor 1140 and the memory 1130 may be otherwise configured to perform or support such operations.

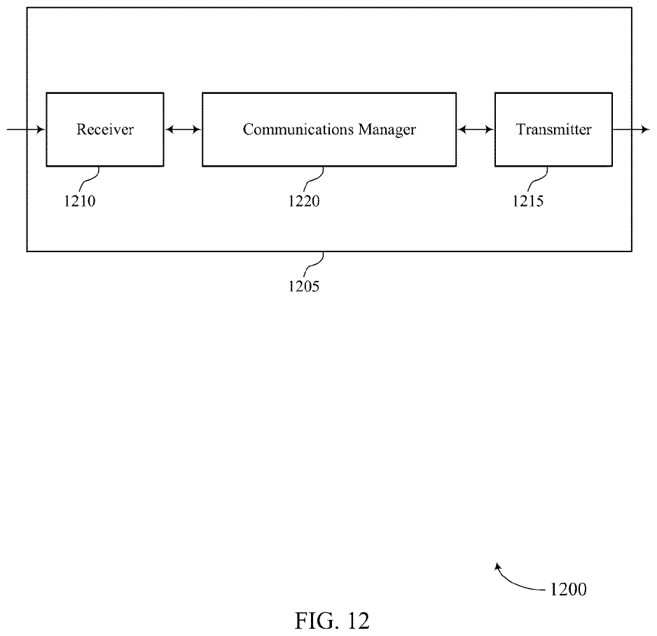

FIG. 12 shows a block diagram 1200 of a device 1205 that supports bit-level probabilistic shaping for wireless communications in accordance with one or more aspects of the present disclosure. The device 1205 may be an example of aspects of a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations thereof or various components thereof may be examples of means for performing various aspects of bit-level probabilistic shaping for wireless communications as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

For example, the communications manager 1220 is capable of, configured to, or operable to support a means for receiving a message from a first wireless device. The communications manager 1220 is capable of, configured to, or operable to support a means for demodulating the message by mapping a set of symbols of a modulation constellation to bits of two or more transformed bit streams in accordance with a Gray mapping, where a probability distribution of the set of symbols prior to the demodulating is monotonic. The communications manager 1220 is capable of, configured to, or operable to support a means for applying a bit transformation to the two or more transformed bit streams in order to generate a corresponding two or more bit streams of non-uniformly distributed bits. The communications manager 1220 is capable of, configured to, or operable to support a means for applying a reverse probabilistic distribution operation to the two or more bit streams of non-uniformly distributed bits to retrieve a data payload of the message. The communications manager 1220 is capable of, configured to, or operable to support a means for processing the data payload.

By including or configuring the communications manager 1220 in accordance with examples as described herein, the device 1205 (e.g., a processor controlling or otherwise coupled with the receiver 1210, the transmitter 1215, the communications manager 1220, or a combination thereof) may support techniques that enable wireless communications to be performed using bit-level probabilistic shaping along with Gray mappings to achieve monotonic distributions for wireless communications. As such, techniques described herein may enable wireless devices to utilize non-Gray mappings for the purposes of probabilistic shaping, while also taking advantage of Gray mappings for the purpose of communicated messages. In this regard, aspects of the present disclosure may enable more efficient and reliable wireless communications (through the use of Gray mappings), while also reducing Tx powers used to communicate messages between devices (through the use of monotonic probability distributions).

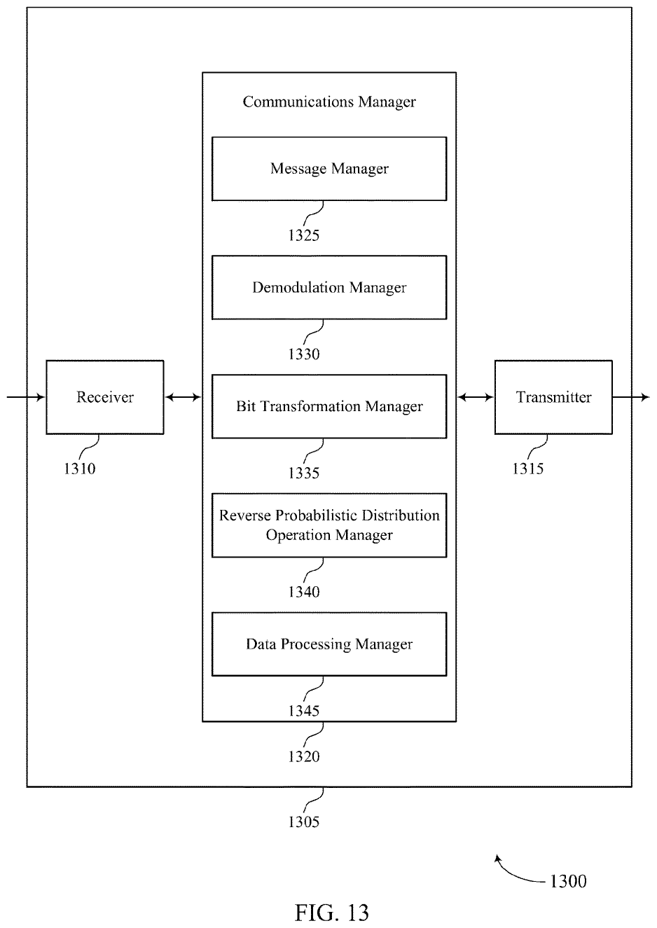

FIG. 13 shows a block diagram 1300 of a device 1305 that supports bit-level probabilistic shaping for wireless communications in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of bit-level probabilistic shaping for wireless communications as described herein. For example, the communications manager 1320 may include a message manager 1325, a demodulation manager 1330, a bit transformation manager 1335, a reverse probabilistic distribution operation manager 1340, a data processing manager 1345, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The message manager 1325 is capable of, configured to, or operable to support a means for receiving a message from a first wireless device. The demodulation manager 1330 is capable of, configured to, or operable to support a means for demodulating the message by mapping a set of symbols of a modulation constellation to bits of two or more transformed bit streams in accordance with a Gray mapping, where a probability distribution of the set of symbols prior to the modulating is monotonic. The bit transformation manager 1335 is capable of, configured to, or operable to support a means for applying a bit transformation to the two or more transformed bit streams in order to generate a corresponding two or more bit streams of non-uniformly distributed bits. The reverse probabilistic distribution operation manager 1340 is capable of, configured to, or operable to support a means for applying a reverse probabilistic distribution operation to the two or more bit streams of non-uniformly distributed bits to retrieve a data payload of the message. The data processing manager 1345 is capable of, configured to, or operable to support a means for processing the data payload.

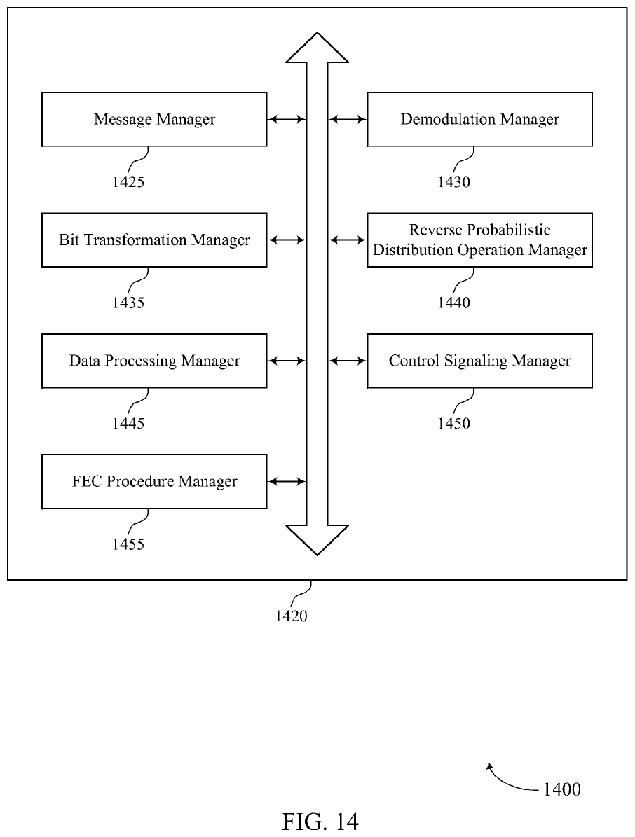

FIG. 14 shows a block diagram 1400 of a communications manager 1420 that supports bit-level probabilistic shaping for wireless communications in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of bit-level probabilistic shaping for wireless communications as described herein. For example, the communications manager 1420 may include a message manager 1425, a demodulation manager 1430, a bit transformation manager 1435, a reverse probabilistic distribution operation manager 1440, a data processing manager 1445, a control signaling manager 1450, an FEC procedure manager 1455, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The message manager 1425 is capable of, configured to, or operable to support a means for receiving a message from a first wireless device. The demodulation manager 1430 is capable of, configured to, or operable to support a means for demodulating the message by mapping a set of symbols of a modulation constellation to bits of two or more transformed bit streams in accordance with a Gray mapping, where a probability distribution of the set of symbols prior to the modulating is monotonic. The bit transformation manager 1435 is capable of, configured to, or operable to support a means for applying a bit transformation to the two or more transformed bit streams in order to generate a corresponding two or more bit streams of non-uniformly distributed bits. The reverse probabilistic distribution operation manager 1440 is capable of, configured to, or operable to support a means for applying a reverse probabilistic distribution operation to the two or more bit streams of non-uniformly distributed bits to retrieve a data payload of the message. The data processing manager 1445 is capable of, configured to, or operable to support a means for processing the data payload.

In some examples, the control signaling manager 1450 is capable of, configured to, or operable to support a means for communicating, with the first wireless device, control signaling that indicates one or more parameters associated with a probabilistic shaping operation performed by the first wireless device, the bit transformation, or both, where application of at least one of the reverse probabilistic distribution operation or the bit transformation is performed in accordance with the one or more parameters.

In some examples, the one or more parameters include a quantity of bits of the data payload that are shaped according to the probabilistic shaping operation, an indication that the probabilistic shaping operation includes a conditional shaping operation, an unconditional shaping operation, or both, a relative ordering between the bit transformation and the probabilistic shaping operation, a shaping distribution of the probabilistic shaping operation, a shaping rate of the probabilistic shaping operation, an indication of the bit transformation applied to the two or more bit streams, or any combination thereof.

In some examples, a mapping of the bits from the two or more bit streams across the set of symbols of the modulation constellation in accordance with the Gray mapping would result in a non-monotonic probability distribution of the set of symbols.

In some examples, first probability distributions corresponding to each of the two or more bit streams are conditionally independent relative to one another. In some examples, second probability distributions corresponding to each of the two or more transformed bit streams are not conditionally independent relative to one another.

In some examples, to support processing the data payload, the FEC procedure manager 1455 is capable of, configured to, or operable to support a means for applying an FEC procedure to the two or more transformed bit streams and to an additional bit stream of uniformly distributed bits, where the additional bit stream of the data payload is retrieved without application of the reverse probabilistic distribution operation or the bit transformation.

In some examples, the reverse probabilistic distribution operation includes a conditional distributional operation. In some examples, application of the reverse probabilistic distribution operation is conditional on the additional bit stream.

In some examples, to support applying the reverse probabilistic distribution operation, the reverse probabilistic distribution operation manager 1440 is capable of, configured to, or operable to support a means for applying the reverse probabilistic distribution operation in parallel to form the two or more bit streams of non-uniformly distributed bits based on the reverse probabilistic distribution operation including the unconditional distributional operation.

In some examples, the bit transformation includes a linear transformation that is configured to convert non-Gray mapped bit streams to Gray-mapped bit streams.

In some examples, the probability distribution of the set of symbols after modulating is monotonic such that symbols closer to on origin of the modulation constellation are associated with a higher distribution probability as compared to symbols further from the origin.

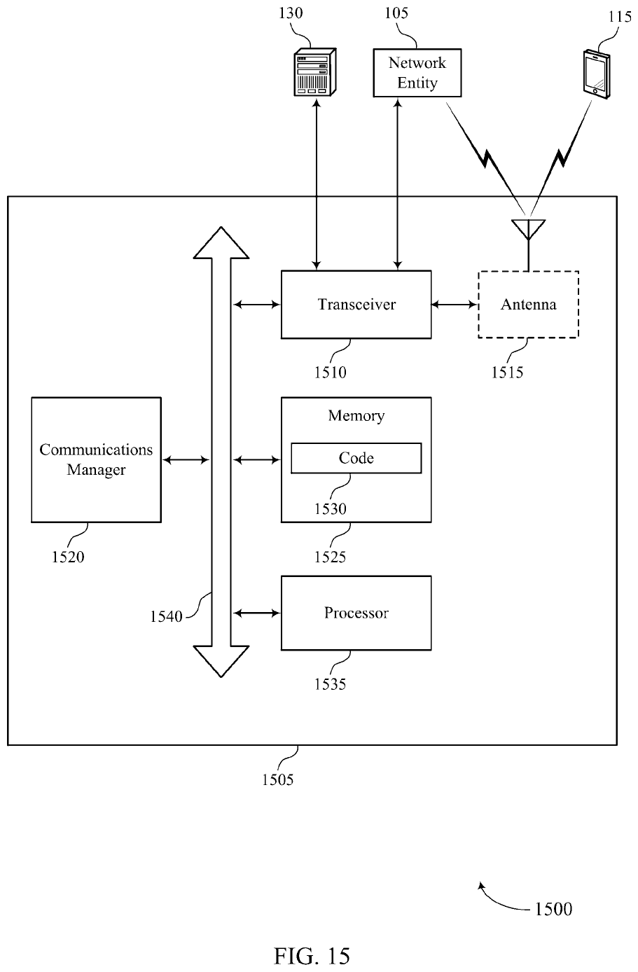

FIG. 15 shows a diagram of a system 1500 including a device 1505 that supports bit-level probabilistic shaping for wireless communications in accordance with one or more aspects of the present disclosure. The device 1505 may be an example of or include the components of a device 1205, a device 1305, or a network entity 105 as described herein. The device 1505 may communicate with one or more network entities 105, one or more UEs 115, or any combination thereof, which may include communications over one or more wired interfaces, over one or more wireless interfaces, or any combination thereof. The device 1505 may include components that support outputting and obtaining communications, such as a communications manager 1520, a transceiver 1510, an antenna 1515, a memory 1525, code 1530, and a processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or memory components (for example, the processor 1535, or the memory 1525, or both), may be included in a chip or chip assembly that is installed in the device 1505. In some examples, the transceiver may be operable to support communications via one or more communications links (e.g., a communication link 125, a backhaul communication link 120, a midhaul communication link 162, a fronthaul communication link 168).

The memory 1525 may include RAM and ROM. The memory 1525 may store computer-readable, computer-executable code 1530 including instructions that, when executed by the processor 1535, cause the device 1505 to perform various functions described herein. The code 1530 may be stored in a non-transitory computer-readable medium such as system memory or another type of memory. In some cases, the code 1530 may not be directly executable by the processor 1535 but may cause a computer (e.g., when compiled and executed) to perform functions described herein. In some cases, the memory 1525 may contain, among other things, a BIOS which may control basic hardware or software operation such as the interaction with peripheral components or devices.

The processor 1535 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1535 may be configured to operate a memory array using a memory controller. In some other cases, a memory controller may be integrated into the processor 1535. The processor 1535 may be configured to execute computer-readable instructions stored in a memory (e.g., the memory 1525) to cause the device 1505 to perform various functions (e.g., functions or tasks supporting bit-level probabilistic shaping for wireless communications). For example, the device 1505 or a component of the device 1505 may include a processor 1535 and memory 1525 coupled with the processor 1535, the processor 1535 and memory 1525 configured to perform various functions described herein. The processor 1535 may be an example of a cloud-computing platform (e.g., one or more physical nodes and supporting software such as operating systems, virtual machines, or container instances) that may host the functions (e.g., by executing code 1530) to perform the functions of the device 1505. The processor 1535 may be any one or more suitable processors capable of executing scripts or instructions of one or more software programs stored in the device 1505 (such as within the memory 1525). In some implementations, the processor 1535 may be a component of a processing system. A processing system may generally refer to a system or series of machines or components that receives inputs and processes the inputs to produce a set of outputs (which may be passed to other systems or components of, for example, the device 1505). For example, a processing system of the device 1505 may refer to a system including the various other components or subcomponents of the device 1505, such as the processor 1535, or the transceiver 1510, or the communications manager 1520, or other components or combinations of components of the device 1505. The processing system of the device 1505 may interface with other components of the device 1505, and may process information received from other components (such as inputs or signals) or output information to other components. For example, a chip or modem of the device 1505 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1505 may transmit information output from the chip or modem. Additionally, or alternatively, in some implementations, the one or more interfaces may refer to an interface between the processing system of the chip or modem and a receiver, such that the device 1505 may obtain information or signal inputs, and the information may be passed to the processing system. A person having ordinary skill in the art will readily recognize that a first interface also may obtain information or signal inputs, and a second interface also may output information or signal outputs.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the memory 1525, the code 1530, and the processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with other network entities 105, and may include a controller or scheduler for controlling communications with UEs 115 in cooperation with other network entities 105. In some examples, the communications manager 1520 may support an X2 interface within an LTE/LTE-A wireless communications network technology to provide communication between network entities 105.

For example, the communications manager 1520 is capable of, configured to, or operable to support a means for receiving a message from a first wireless device. The communications manager 1520 is capable of, configured to, or operable to support a means for demodulating the message by mapping a set of symbols of a modulation constellation to bits of two or more transformed bit streams in accordance with a Gray mapping, where a probability distribution of the set of symbols prior to the demodulation is monotonic. The communications manager 1520 is capable of, configured to, or operable to support a means for applying a bit transformation to the two or more transformed bit streams in order to generate a corresponding two or more bit streams of non-uniformly distributed bits. The communications manager 1520 is capable of, configured to, or operable to support a means for applying a reverse probabilistic distribution operation to the two or more bit streams of non-uniformly distributed bits to retrieve a data payload of the message. The communications manager 1520 is capable of, configured to, or operable to support a means for processing the data payload.

By including or configuring the communications manager 1520 in accordance with examples as described herein, the device 1505 may support techniques that enable wireless communications to be performed using bit-level probabilistic shaping along with Gray mappings to achieve monotonic distributions for wireless communications. As such, techniques described herein may enable wireless devices to utilize non-Gray mappings for the purposes of probabilistic shaping, while also taking advantage of Gray mappings for the purpose of communicated messages. In this regard, aspects of the present disclosure may enable more efficient and reliable wireless communications (through the use of Gray mappings), while also reducing Tx powers used to communicate messages between devices (through the use of monotonic probability distributions).

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, the processor 1535, the memory 1525, the code 1530, or any combination thereof. For example, the code 1530 may include instructions executable by the processor 1535 to cause the device 1505 to perform various aspects of bit-level probabilistic shaping for wireless communications as described herein, or the processor 1535 and the memory 1525 may be otherwise configured to perform or support such operations.

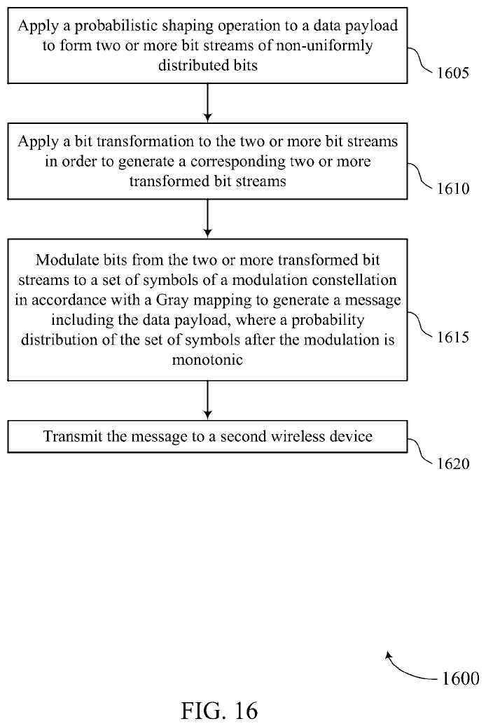

FIG. 16 shows a flowchart illustrating a method 1600 that supports bit-level probabilistic shaping for wireless communications in accordance with aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the wireless UE to perform the described functions. Additionally, or alternatively, the wireless UE may perform aspects of the described functions using special-purpose hardware.

At 1605, the method may include applying a probabilistic shaping operation to a data payload to form two or more bit streams of non-uniformly distributed bits. The operations of 1605 may be performed in accordance with examples as disclosed herein. In some examples, aspects of the operations of 1605 may be performed by a shaping operation manager 1025 as described with reference to FIG. 10.

At 1610, the method may include applying a bit transformation to the two or more bit streams in order to generate a corresponding two or more transformed bit streams. The operations of 1610 may be performed in accordance with examples as disclosed herein. In some examples, aspects of the operations of 1610 may be performed by a bit transformation manager 1030 as described with reference to FIG. 10.

At 1615, the method may include modulating bits from the two or more transformed bit streams to a set of symbols of a modulation constellation in accordance with a Gray mapping to generate a message including the data payload, where a probability distribution of the set of symbols after the modulating is monotonic. The operations of 1615 may be performed in accordance with examples as disclosed herein. In some examples, aspects of the operations of 1615 may be performed by a modulation manager 1035 as described with reference to FIG. 10.

At 1620, the method may include transmitting the message to a second wireless device. The operations of 1620 may be performed in accordance with examples as disclosed herein. In some examples, aspects of the operations of 1620 may be performed by a message manager 1040 as described with reference to FIG. 10.

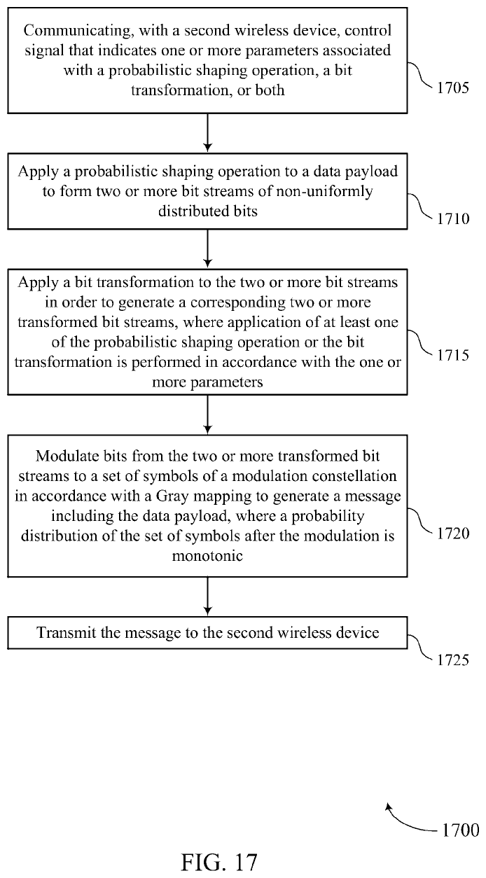

FIG. 17 shows a flowchart illustrating a method 1700 that supports bit-level probabilistic shaping for wireless communications in accordance with aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the wireless UE to perform the described functions. Additionally, or alternatively, the wireless UE may perform aspects of the described functions using special-purpose hardware.

At 1705, the method may include communicating, with a second wireless device, control signaling that indicates one or more parameters associated with a probabilistic shaping operation, a bit transformation, or both. The operations of 1705 may be performed in accordance with examples as disclosed herein. In some examples, aspects of the operations of 1705 may be performed by a control signaling manager 1045 as described with reference to FIG. 10.

At 1710, the method may include applying a probabilistic shaping operation to a data payload to form two or more bit streams of non-uniformly distributed bits. The operations of 1710 may be performed in accordance with examples as disclosed herein. In some examples, aspects of the operations of 1710 may be performed by a shaping operation manager 1025 as described with reference to FIG. 10.

At 1715, the method may include applying a bit transformation to the two or more bit streams in order to generate a corresponding two or more transformed bit streams, where application of at least one of the probabilistic shaping operation or the bit transformation is performed in accordance with the one or more parameters. The operations of 1715 may be performed in accordance with examples as disclosed herein. In some examples, aspects of the operations of 1715 may be performed by a bit transformation manager 1030 as described with reference to FIG. 10.

At 1720, the method may include modulating bits from the two or more transformed bit streams to a set of symbols of a modulation constellation in accordance with a Gray mapping to generate a message including the data payload, where a probability distribution of the set of symbols after the modulating is monotonic. The operations of 1720 may be performed in accordance with examples as disclosed herein. In some examples, aspects of the operations of 1720 may be performed by a modulation manager 1035 as described with reference to FIG. 10.

At 1725, the method may include transmitting the message to the second wireless device. The operations of 1725 may be performed in accordance with examples as disclosed herein. In some examples, aspects of the operations of 1725 may be performed by a message manager 1040 as described with reference to FIG. 10.

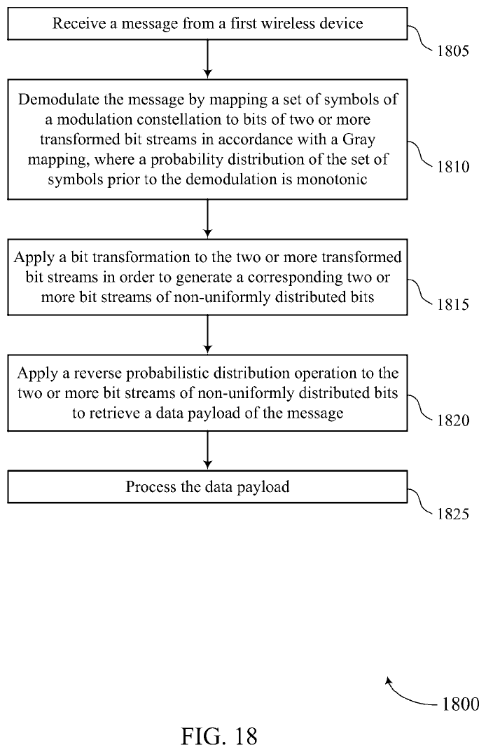

FIG. 18 shows a flowchart illustrating a method 1800 that supports bit-level probabilistic shaping for wireless communications in accordance with aspects of the present disclosure. The operations of the method 1800 may be implemented by a network entity or its components as described herein. For example, the operations of the method 1800 may be performed by a network entity as described with reference to FIGS. 1 through 7 and 12 through 15. In some examples, a network entity may execute a set of instructions to control the functional elements of the wireless network entity to perform the described functions. Additionally, or alternatively, the wireless network entity may perform aspects of the described functions using special-purpose hardware.

At 1805, the method may include receiving a message from a first wireless device. The operations of 1805 may be performed in accordance with examples as disclosed herein. In some examples, aspects of the operations of 1805 may be performed by a message manager 1425 as described with reference to FIG. 14.

At 1810, the method may include demodulating the message by mapping a set of symbols of a modulation constellation to bits of two or more transformed bit streams in accordance with a Gray mapping, where a probability distribution of the bits across the set of symbols prior to the demodulation is monotonic. The operations of 1810 may be performed in accordance with examples as disclosed herein. In some examples, aspects of the operations of 1810 may be performed by a demodulation manager 1430 as described with reference to FIG. 14.

At 1815, the method may include applying a bit transformation to the two or more transformed bit streams in order to generate a corresponding two or more bit streams of non-uniformly distributed bits. The operations of 1815 may be performed in accordance with examples as disclosed herein. In some examples, aspects of the operations of 1815 may be performed by a bit transformation manager 1435 as described with reference to FIG. 14.

At 1820, the method may include applying a reverse probabilistic distribution operation to the two or more bit streams of non-uniformly distributed bits to retrieve a data payload of the message. The operations of 1820 may be performed in accordance with examples as disclosed herein. In some examples, aspects of the operations of 1820 may be performed by a reverse probabilistic distribution operation manager 1440 as described with reference to FIG. 14.

At 1825, the method may include processing the data payload. The operations of 1825 may be performed in accordance with examples as disclosed herein. In some examples, aspects of the operations of 1825 may be performed by a data processing manager 1445 as described with reference to FIG. 14.

The following provides an overview of aspects of the present disclosure:

### Aspect 1

A method for wireless communications at a first wireless device, comprising: applying a probabilistic shaping operation to a data payload to form two or more bit streams of non-uniformly distributed bits; applying a bit transformation to the two or more bit streams in order to generate a corresponding two or more transformed bit streams; modulating bits from the two or more transformed bit streams to a set of symbols of a modulation constellation in accordance with a Gray mapping to generate a message comprising the data payload, wherein a probability distribution of the set of symbols after the modulating is monotonic; and transmitting the message to a second wireless device.

### Aspect 2

The method of aspect 1, further comprising: communicating, with the second wireless device, control signaling that indicates one or more parameters associated with the probabilistic shaping operation, the bit transformation, or both, wherein application of at least one of the probabilistic shaping operation or the bit transformation is performed in accordance with the one or more parameters.

### Aspect 3

The method of aspect 2, wherein the one or more parameters comprise a quantity of bits of the data payload that are shaped according to the probabilistic shaping operation, an indication that the probabilistic shaping operation comprises a conditional shaping operation, an unconditional shaping operation, or both, a relative ordering between the bit transformation and the probabilistic shaping operation, a shaping distribution of the probabilistic shaping operation, a shaping rate of the probabilistic shaping operation, an indication of the bit transformation applied to the two or more bit streams, or any combination thereof.

### Aspect 4

The method of any of aspects 1 through 3, wherein a mapping of the bits from the two or more bit streams across the set of symbols of the modulation constellation in accordance with the Gray mapping would result in a non-monotonic probability distribution of the set of symbols.

### Aspect 5

The method of any of aspects 1 through 4, wherein applying the probabilistic shaping operation results in respective first probability distributions corresponding to each of the two or more bit streams being conditionally independent relative to one another, and applying the bit transformation results in respective second probability distributions corresponding to each of the two or more transformed bit streams being not conditionally independent relative to one another.

### Aspect 6

The method of any of aspects 1 through 5, further comprising: applying an FEC procedure to the two or more transformed bit streams and to an additional bit stream of uniformly distributed bits, wherein the additional bit stream is derived from the data payload without application of the probabilistic shaping operation or the bit transformation, and wherein modulating the bits of the two or more transformed bit streams is performed based at least in part on applying the FEC procedure.

### Aspect 7

The method of aspect 6, wherein the probabilistic shaping operation comprises a conditional shaping operation, probabilistic shaping of the two or more bit streams is conditional on the additional bit stream.

### Aspect 8

The method of any of aspects 1 through 7, wherein the probabilistic shaping operation comprises an unconditional shaping operation, wherein applying the probabilistic shaping operation comprises: applying the probabilistic shaping operation in parallel to form the two or more bit streams of non-uniformly distributed bits based at least in part on the probabilistic shaping operation comprising the unconditional shaping operation.

### Aspect 9

The method of any of aspects 1 through 8, wherein the probabilistic shaping operation comprises a conditional shaping operation including a first shaping operation and a second shaping operation, and wherein the two or more bit streams comprise a first bit stream and a second bit stream, wherein applying the probabilistic shaping operation comprises: applying the first shaping operation to form the first bit stream of non-uniformly distributed bits; and applying the second shaping operation to form the second bit stream of non-uniformly distributed bits based at least in part on shaping the first bit stream, and based at least in part on the probabilistic shaping operation comprising the conditional shaping operation.

### Aspect 10

The method of aspect 9, further comprising: applying the first shaping operation in accordance with a target distribution to form the first bit stream of non-uniformly distributed bits, wherein application of the second shaping operation is conditional on the first bit stream.

### Aspect 11

The method of any of aspects 1 through 10, further comprising: applying an additional probabilistic shaping operation to form a third bit stream of non-uniformly distributed bits, wherein application of the additional probabilistic shaping operation is conditional on the two or more bit streams or the two or more transformed bit streams; and applying the bit transformation to the third bit stream to generate a third transformed bit stream corresponding to the third bit stream, wherein modulating the bits of the two or more transformed bit streams is based at least in part on mapping the third transformed bit stream to the modulation constellation.

### Aspect 12

The method of any of aspects 1 through 11, wherein the bit transformation comprises a linear transformation that is configured to convert bit streams associated with a non-Gray mapping to bit streams associated with a Gray mapping.

### Aspect 13

The method of aspect 12, wherein the two or more bit streams include a first bit stream and a second bit stream associated with non-Gray mappings, and the linear transformation is configured to transform the first bit stream to a first transformed bit stream associated with a Gray mapping, and transform a combination of the first bit stream and the second bit stream to a second transformed bit stream associated with a second Gray mapping.

### Aspect 14

The method of any of aspects 1 through 13, wherein the probability distribution of the set of symbols after the modulating is monotonic such that symbols of the modulation constellation with lower magnitudes or transmit powers are associated with a higher distribution probability as compared to symbols with higher magnitudes or transmit powers.

### Aspect 15

A method for wireless communications at a second wireless device, comprising: receiving a message from a first wireless device; demodulating the message by mapping a set of symbols of a modulation constellation to bits of two or more transformed bit streams in accordance with a Gray mapping, wherein a probability distribution of the set of symbols prior to the demodulating is monotonic; applying a bit transformation to the two or more transformed bit streams in order to generate a corresponding two or more bit streams of non-uniformly distributed bits; applying a reverse probabilistic distribution operation to the two or more bit streams of non-uniformly distributed bits to retrieve a data payload of the message; and processing the data payload.

### Aspect 16

The method of aspect 15, further comprising: communicating, with the first wireless device, control signaling that indicates one or more parameters associated with a probabilistic shaping operation performed by the first wireless device, the bit transformation, or both, wherein application of at least one of the reverse probabilistic distribution operation or the bit transformation is performed in accordance with the one or more parameters.

### Aspect 17

The method of aspect 16, wherein the one or more parameters comprise a quantity of bits of the data payload that are shaped according to the probabilistic shaping operation, an indication that the probabilistic shaping operation comprises a conditional shaping operation, an unconditional shaping operation, or both, a relative ordering between the bit transformation and the probabilistic shaping operation, a shaping distribution of the probabilistic shaping operation, a shaping rate of the probabilistic shaping operation, an indication of the bit transformation applied to the two or more bit streams, or any combination thereof.

### Aspect 18

The method of any of aspects 15 through 17, wherein a mapping of the bits from the two or more bit streams across the set of symbols of the modulation constellation in accordance with the Gray mapping would result in a non-monotonic probability distribution of the set of symbols.

### Aspect 19

The method of any of aspects 15 through 18, wherein first probability distributions corresponding to each of the two or more bit streams are conditionally independent relative to one another, and second probability distributions corresponding to each of the two or more transformed bit streams are not conditionally independent relative to one another.

### Aspect 20

The method of any of aspects 15 through 19, wherein processing the data payload comprises: applying an FEC procedure to the two or more transformed bit streams and to an additional bit stream of uniformly distributed bits, wherein the additional bit stream of the data payload is retrieved without application of the reverse probabilistic distribution operation or the bit transformation.

### Aspect 21

The method of aspect 20, wherein the reverse probabilistic distribution operation comprises a conditional distributional operation, application of the reverse probabilistic distribution operation is conditional on the additional bit stream.

### Aspect 22

The method of any of aspects 15 through 21, wherein the reverse probabilistic distribution operation comprises an unconditional distributional operation, wherein applying the reverse probabilistic distribution operation comprises: applying the reverse probabilistic distribution operation in parallel to form the two or more bit streams of non-uniformly distributed bits based at least in part on the reverse probabilistic distribution operation comprising the unconditional distributional operation.

### Aspect 23

The method of any of aspects 15 through 22, wherein the bit transformation comprises a linear transformation that is configured to convert non-Gray mapped bit streams to Gray-mapped bit streams.

### Aspect 24

The method of any of aspects 15 through 23, wherein the probability distribution of the set of symbols prior to the demodulating is monotonic such that symbols closer to on origin of the modulation constellation are associated with a higher distribution probability as compared to symbols further from the origin.

### Aspect 25

An apparatus comprising a processor; memory coupled with the processor; and instructions stored in the memory and executable by the processor to cause the apparatus to perform a method of any of aspects 1 through 14.

### Aspect 26

An apparatus comprising at least one means for performing a method of any of aspects 1 through 14.

### Aspect 27

A non-transitory computer-readable medium storing code the code comprising instructions executable by a processor to perform a method of any of aspects 1 through 14.

### Aspect 28

An apparatus comprising a processor; memory coupled with the processor; and instructions stored in the memory and executable by the processor to cause the apparatus to perform a method of any of aspects 15 through 24.

### Aspect 29

An apparatus comprising at least one means for performing a method of any of aspects 15 through 24.

### Aspect 30

A non-transitory computer-readable medium storing code the code comprising instructions executable by a processor to perform a method of any of aspects 15 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A first wireless device, comprising:
a processor;
memory coupled with the processor; and
instructions stored in the memory and executable by the processor to cause the first wireless device to:
apply a probabilistic shaping operation to a data payload to form two or more bit streams of non-uniformly distributed bits;
apply a bit transformation to the two or more bit streams in order to generate a corresponding two or more transformed bit streams;
modulate bits from the two or more transformed bit streams to a set of symbols of a modulation constellation in accordance with a Gray mapping to generate a message comprising the data payload, wherein a probability distribution of the set of symbols after the modulating is monotonic; and
transmit the message to a second wireless device.

2. The first wireless device of claim 1, wherein the instructions are further executable by the processor to cause the first wireless device to:
communicate, with the second wireless device, control signaling that indicates one or more parameters associated with the probabilistic shaping operation, the bit transformation, or both, wherein application of at least one of the probabilistic shaping operation or the bit transformation is performed in accordance with the one or more parameters.

3. The first wireless device of claim 2, wherein the one or more parameters comprise a quantity of bits of the data payload that are shaped according to the probabilistic shaping operation, an indication that the probabilistic shaping operation comprises a conditional shaping operation, an unconditional shaping operation, or both, a relative ordering between the bit transformation and the probabilistic shaping operation, a shaping distribution of the probabilistic shaping operation, a shaping rate of the probabilistic shaping operation, an indication of the bit transformation applied to the two or more bit streams, or any combination thereof.

4-5. (canceled)

6. The first wireless device of claim 1, wherein the instructions are further executable by the processor to cause the first wireless device to:
apply a forward error correction procedure to the two or more transformed bit streams and to an additional bit stream of uniformly distributed bits, wherein the additional bit stream is derived from the data payload without application of the probabilistic shaping operation or the bit transformation, and wherein modulating the bits of the two or more transformed bit streams is performed based at least in part on applying the forward error correction procedure.

7. The first wireless device of claim 6, wherein the probabilistic shaping operation comprises a conditional shaping operation, wherein probabilistic shaping of the two or more bit streams is conditional on the additional bit stream.

8. The first wireless device of claim 1, wherein the probabilistic shaping operation comprises an unconditional shaping operation, wherein the instructions to apply the probabilistic shaping operation are executable by the processor to cause the first wireless device to:
apply the probabilistic shaping operation in parallel to form the two or more bit streams of non-uniformly distributed bits based at least in part on the probabilistic shaping operation comprising the unconditional shaping operation.

9. The first wireless device of claim 1, wherein the probabilistic shaping operation comprises a conditional shaping operation including a first shaping operation and a second shaping operation, and wherein the two or more bit streams comprise a first bit stream and a second bit stream, wherein the instructions to apply the probabilistic shaping operation are executable by the processor to cause the first wireless device to:
apply the first shaping operation to form the first bit stream of non-uniformly distributed bits; and
apply the second shaping operation to form the second bit stream of non-uniformly distributed bits based at least in part on shaping the first bit stream, and based at least in part on the probabilistic shaping operation comprising the conditional shaping operation.

10. The first wireless device of claim 9, wherein the instructions are further executable by the processor to cause the first wireless device to:
apply the first shaping operation in accordance with a target distribution to form the first bit stream of non-uniformly distributed bits, wherein application of the second shaping operation is conditional on the first bit stream.

11. The first wireless device of claim 1, wherein the instructions are further executable by the processor to cause the first wireless device to:
apply an additional probabilistic shaping operation to form a third bit stream of non-uniformly distributed bits, wherein application of the additional probabilistic shaping operation is conditional on the two or more bit streams or the two or more transformed bit streams; and
apply the bit transformation to the third bit stream to generate a third transformed bit stream corresponding to the third bit stream, wherein modulating the bits of the two or more transformed bit streams is based at least in part on mapping the third transformed bit stream to the modulation constellation.

12. (canceled)

13. The first wireless device of claim 1, wherein the two or more bit streams include a first bit stream and a second bit stream associated with non-Gray mappings, and wherein a linear transformation is configured to transform the first bit stream to a first transformed bit stream associated with a Gray mapping, and transform a combination of the first bit stream and the second bit stream to a second transformed bit stream associated with a second Gray mapping.

14. (canceled)

15. A second wireless device, comprising:
a processor;
memory coupled with the processor; and
instructions stored in the memory and executable by the processor to cause the second wireless device to:
receive a message from a first wireless device;
demodulate the message by mapping a set of symbols of a modulation constellation to bits of two or more transformed bit streams in accordance with a Gray mapping, wherein a probability distribution of the set of symbols prior to the demodulation is monotonic;
apply a bit transformation to the two or more transformed bit streams in order to generate a corresponding two or more bit streams of non-uniformly distributed bits;
apply a reverse probabilistic distribution operation to the two or more bit streams of non-uniformly distributed bits to retrieve a data payload of the message; and
process the data payload.

16. The second wireless device of claim 15, wherein the instructions are further executable by the processor to cause the second wireless device to:
communicate, with the first wireless device, control signaling that indicates one or more parameters associated with a probabilistic shaping operation performed by the first wireless device, the bit transformation, or both, wherein application of at least one of the reverse probabilistic distribution operation or the bit transformation is performed in accordance with the one or more parameters.

17. The second wireless device of claim 16, wherein the one or more parameters comprise a quantity of bits of the data payload that are shaped according to the probabilistic shaping operation, an indication that the probabilistic shaping operation comprises a conditional shaping operation, an unconditional shaping operation, or both, a relative ordering between the bit transformation and the probabilistic shaping operation, a shaping distribution of the probabilistic shaping operation, a shaping rate of the probabilistic shaping operation, an indication of the bit transformation applied to the two or more bit streams, or any combination thereof.

18-19. (canceled)

20. The second wireless device of claim 15, wherein the instructions to process the data payload are executable by the processor to cause the second wireless device to:
apply a forward error correction procedure to the two or more transformed bit streams and to an additional bit stream of uniformly distributed bits, wherein the additional bit stream of the data payload is retrieved without application of the reverse probabilistic distribution operation or the bit transformation.

21. The second wireless device of claim 20, wherein the reverse probabilistic distribution operation comprises a conditional distributional operation, wherein application of the reverse probabilistic distribution operation is conditional on the additional bit stream.

22. The second wireless device of claim 15, wherein the reverse probabilistic distribution operation comprises an unconditional distributional operation, wherein the instructions to apply the reverse probabilistic distribution operation are executable by the processor to cause the second wireless device to:
apply the reverse probabilistic distribution operation in parallel to form the two or more bit streams of non-uniformly distributed bits based at least in part on the reverse probabilistic distribution operation comprising the unconditional distributional operation.

23. The second wireless device of claim 15, wherein the bit transformation comprises a linear transformation that is configured to convert non-Gray mapped bit streams to Gray-mapped bit streams.

24. (canceled)

25. A method for wireless communications at a first wireless device, comprising:
applying a probabilistic shaping operation to a data payload to form two or more bit streams of non-uniformly distributed bits;
applying a bit transformation to the two or more bit streams in order to generate a corresponding two or more transformed bit streams;
modulating bits from the two or more transformed bit streams to a set of symbols of a modulation constellation in accordance with a Gray mapping to generate a message comprising the data payload, wherein a probability distribution of the set of symbols after the modulating is monotonic; and
transmitting the message to a second wireless device.

26. The method of claim 25, further comprising:
communicating, with the second wireless device, control signaling that indicates one or more parameters associated with the probabilistic shaping operation, the bit transformation, or both, wherein application of at least one of the probabilistic shaping operation or the bit transformation is performed in accordance with the one or more parameters.

27. The method of claim 26, wherein the one or more parameters comprise a quantity of bits of the data payload that are shaped according to the probabilistic shaping operation, an indication that the probabilistic shaping operation comprises a conditional shaping operation, an unconditional shaping operation, or both, a relative ordering between the bit transformation and the probabilistic shaping operation, a shaping distribution of the probabilistic shaping operation, a shaping rate of the probabilistic shaping operation, an indication of the bit transformation applied to the two or more bit streams, or any combination thereof.

28-30. (canceled)
